(19) United States
(12) Patent Application Publication
(10) Pub. No.: US 2004/0000515 A1
(43) Pub. Date: Jan. 1, 2004

(54) Filter back-flushing reaction chamber apparatus

(76) Inventors: James Jeffrey Harris, Cameron Park, CA (US); James William Harris, Golden, CO (US)

Correspondence Address: James Jeffrey Harris PE, 2592 Westbridge Drive, Cameron Park, CA, 95682, US

(21) Appl. No.: 10/180,682

(22) Filed: Jun. 26, 2002

(51) Int. Cl. B01D 29/66

(52) U.S. Cl. 210/411

(57) ABSTRACT

An apparatus for enhanced cleaning of a filter unit, said apparatus being comprised of a closed reaction chamber body (25) adapted to receive and store in a reaction chamber (35) back-flush fluid, preferably filtrate, further adapted with access porting to chemically treat (30) and monitor (34) and to thermally (32) treat and monitor (33) said stored fluid and further adapted to receive (28) and vent (29) compressed gas into the gravitationally oriented upper section of the reaction chamber (35). Said reaction chamber (35) being further provided therein with conveyance tubing (8) so configured to facilitate hydraulic communication between the gravitationally oriented lower section of the reaction chamber (35) and a back-flush fluid inlet port of the filter unit being served. The conveyance tubes (8) and the reaction chamber (35) being co-oriented in a substantially vertical direction. The conveyance tubes (8) being so configured that the lower ends (26) are open to the reaction chamber while the upper sections pass through the sealing plate (17) at the top of the reaction chamber (35) and direct toward the back-flush inlet port of the filter unit. Said conveyance tubes (8) being further provided with orifice perforations (27) in the area proximate to the upper section of the reaction chamber (35). Said orifice perforations (27) therein provided to facilitate back flush enhancement of the chemically and thermally treated back flush fluid by means of atomization and entrainment of the high pressure gas bled from the reaction chamber (35) into the conveyance tubes (8) antecedent to discharge from the apparatus to the serviced filter unit.

Wherein to facilitate back flush cleaning of the serviced filter unit, high pressure gas is admitted into the gas inlet port (28) to pressurize, displace and force the back flush fluid downward in the reaction chamber (35), into the open lower ends (26) of the conveyance tubes (8), upward in the conveyance tubes (8), past the orifice perforations (27),wherein high pressure gas is atomized and entrained and passed onwards from the apparatus to the back flush inlet port of the filter unit.

### BACKGROUND

1. Field of Invention

This invention relates to a method and apparatus with the focus of providing a more efficient, reliable and cost effective means for the back flush cleansing of filtering mechanisms. Specifically the invention is directed to providing an improved method and apparatus to facilitate efficient, reliable and cost effective back flush cleansing of stacked disk filtration mechanisms.

2. Description of Prior Art

Modern industry and agriculture both require filtration technologies of varying capacities. Initially, innovative and higher efficiency filtration technologies evolved primarily out of the industrial market needs with agricultural filtration needs being satisfied by relatively simple and somewhat crude technologies. Concurrent with worldwide agricultural growth, and specifically as a consequence of the development of highly efficient drip tube irrigation technologies, the demand and consequential development of much more efficient, yet cost effective and reliable agricultural filtration processes burgeoned. Indeed, the previous trend of agricultural filtration technologies being primarily low cost derivatives of industrial designs has been superseded by the current industrial interest in employing modern agricultural derived technologies to industry. In many cases, adaptation of agricultural based filtration technologies into industrial applications have been positive and straight forward. Other industrial applications however, have encountered problems.

A major problem, which is primarily associated with industrial applications, relates to the inability to adequately flush clean the filtration media. In these situations, collected solids strongly adhere to the surfaces of the filtration media, thereby engendering cumulative plugging. The consequence of this plugging action is an increased back flush cleaning cycle frequency and eventual loss of filtration service. Resolution of this problem typically involves removal of the effected filter from service followed by manual disassembly and cleaning or replacement of the effected media. The cumulative plugging results in a high cleaning cycle frequency, which stresses and wears valves and other moving components. High maintenance and operating costs as well as impaired reliability ensues from this excessive stress and wear. Further, the cost and liability of manual disassembly and cleaning are major factors in limiting filtration service to such industrial applications. Additionally, the eventual loss of filtration performance negatively impacts the industrial process being served. The resolution of these issues, particularly as they apply to disk filtration technologies, are the primary focus of this invention.

Disk filtration technology has been developed over many decades. There are generally two categories referenced in the art as disk filtration. One such category incorporates the parallel mounting of one or more disks comprised of a screening material encapsulating a substantially hollow platelike structure which is generally mounted on a filtrate conduit. In such art, the filtration process occurs across the disk encapsulating screens wherein the screens may or may not include the provision of a filter aid coating such as diatomaceous earth. This subcategory of filtration technology has been commonly employed in industry for decades.

The second category of disk filtration has been developed primarily, though not exclusively, through agricultural needs. This category is the primary focus of this invention. This category of the art embodies the employment of multiple ring-type disks, generally, though not always, made of a plastic material, stacked together to compose a primarily hollow cylindrical assemblage. Unfiltered water is forced, under pressure, to pass between these disks in a substantially radial direction, typically from the external to the internal side of the stack. Various types of protrusions or surface topology of the disks provide for the catchment of particulate matter suspended in the fluid. The trammeling of particles thereby occurring upon the external surface of the cylindrical assemblage and/or upon the contacting surfaces of the disks. Wherein for clarity, the catchment surface external to the stack is substantially perpendicular to the direction of flow while that of the contacting surfaces is substantially coplanar with the direction of flow. The filtrate typically exits internal to the hollow disk stack and is ported from there to process for use.

The geometrical configuration and associated filtration mechanism of the disks as defined in the prior art are diverse. Reference is made to an early disk filter process wherein tapered disks with radially internal filtrate porting was proposed for removal of a disperse sizing of particles is demonstrated in U.S. Pat. No. 1,643,299.

Other configurations practiced in the art are delineated in U.S. Pat. Nos. 2,847,126, 3,648,843, 3,827,568, 4,430,232, 4,707,259 and 4,726,900. In these practices perturbations and/or other spacing mechanisms are embodied on the disk surfaces so as to facilitate geometrical spacing between adjacent disks consistent with the required filtration size or grade. In such art the unfiltered water is constrained to pass radially between the disks of the cylindrical assemblage. Particles larger than the disk spacings therefore being trammeled upstream of the constrained fluid path. Various manifestations of this art have been further proposed in which the upstream configuration of the disks is so modified as to provide for a increased upstream surface lineage, thereby providing for an enhanced particle trammeling area. Reference is made to U.S. Pat. No. 4,410,430.

Further lessons of the art demonstrate the employment of surface grooves on one or both sides of the disks for the provision of flow channels between abutted disks. The size and geometry of said channels being the constraint on the passage of particles. Particles of sufficient size are trammeled at the entrance to the groove channels. Reference to these developments of the art are provided in U.S. Pat. Nos. 1,642,864 and 3,195,730.

As is compulsory with filtration processes in general, disk filtration processes require some means of filtration media surface cleansing to remove the collected solids separated from the treated fluid. Some examples of the prior art show little discussion of this issue. It can only be assumed that in these cases either disposal or disassembly and manual cleaning must be the procedure of choice. The drawback of the disposal option being the expense of replacement. The disadvantage of the disassembly and cleaning option being the expense of labor and associated process downtime.

Prior art has evinced many examples in which the disks are cleaned through mechanical means and/or hydraulic means. Such means being accomplished in automated, semi-automated or manually implemented processes.

An example cited in the prior art of a mechanical means for cleaning, demonstrates a procedure wherein the disks are rotated relative to one another providing a scraping mechanism and thereby facilitating removal of the collected debris. Reference U.S. Pat. No. 1,926,557 as an example of such art. The detriments inherent in this art are the mechanical complexities involved in maintaining the proper relative disk orientations and the rotary mechanisms necessary to facilitate the relative disk rotations. This art also suffers from the detrimental tendency to smear or extrude rather than remove those collected solids which are soft and pliable.

Prior art has demonstrated other mechanical cleaning methods wherein brushes are employed to clean accumulated debris from the outer cylinder assemblage surface. Reference is made to U.S. Pat. No. 2,422,735 relating to such an invention. This example of the art suffers from mechanical complexity, high wear problems and fouling of the brushes.

Prior art has cited many examples of hydraulic cleaning processes. In this embodiment of the art, a washing liquid, generally filtrate, is directed to flush the collected solids debris from the disk stack. In the simplest form of the art, filtrate is forced to flow in a reverse or back flushing manner through the filter with the aim of dislodging, separating and transporting collected solids from the filter. This solids entrained back flush fluid is then generally ported aside for further processing or discharge.

An agricultural application where such a cleaning process has found common use is in irrigation line pre-filtration systems. In these systems, a plurality of filtration bodies containing disk filter stacks are operated in a parallel manner between a common inlet manifold and a common outlet manifold. In such configurations, pressurized, unfiltered irrigation water passes from the inlet manifold through the filters, where the solids are collected, and enters into the slightly less pressured outlet manifold as filtrate. The hydraulic design of the irrigation and filtration system is so constrained as to sustain a sufficiently pressurized outlet manifold when flow from one of the filter bodies is eliminated and flow from the others is slightly reduced. An embodiment wherein the pressurized filtrate from the outlet manifold is employed for back flushing of the filters is a consequence of such a hydraulic design. In this design the inlet to a chosen filtration body is diverted by valving means from communication with the inlet manifold to communication with a waste back flush manifold. The pressure in the waste back flush manifold is maintained at a level substantially lower than that of the outlet manifold. As a consequence of this pressure differential, filtrate from the outlet manifold flows in a reverse manner through the chosen filter body and associated disk filter stack into the waste back flush manifold. Solids collected on the filter stack surfaces are dislodged and conveyed into the waste back flush manifold for eventual discharge. Subsequent to cleaning, the filter is brought back into the filtration mode by means of valved restoration of communication to the inlet manifold and isolation from the waste back flush manifold. The filtration system cleaning process then continues with sequential repetition of similar back flushing operations on the remaining filter bodies in the system. This embodiment of the art has historically found abundant applications, though it suffers substantially from inherent inadequacies in cleansing efficiency of the disk filtration surfaces. Said inadequacies result from channeling of back flushing filtrate through the disk stacks and insufficient reverse flowing filtrate energy and cleaning activity to adequately dislodge solids adhered to the filtration surfaces. As a result, such embodiments have proven to be labor intensive with excessive maintenance associated with periodic manual cleaning of the filtration disk stacks. Mechanical failures and associated reliability concerns are particularly troublesome when the cleaning cycle frequency is high, as is a consequence of incomplete cleaning of the disks.

In response to the inadequacies of the simple reverse flowing filtrate back flushing process, further developments of the art have been cited. To reduce channeling effects and to mechanically assist in dislodging solids adhered to the filtration surfaces several embodiments of the art have been cited wherein the filter disk cylindrical assemblage is opened. In such an action the compression force, which normally holds the disks tightly together to facilitate the filtration process, is removed in such a fashion that the disk stack is substantially opened and the filtration disks rendered free floating. Reverse flowing filtrate is then directed through the open disk stack to flush the collected solids debris from the opened and now accessible filtration surfaces. Upon completion of flushing, the disks are brought back together in compression and the filtration process resumed. Reference is made to U.S. Pat. Nos. 4,156,651, 4,402,829, 4,592,839 and 4,714,552 for examples cited to this art. These developments, though somewhat successful in improving the cleaning efficiency of the disks, still suffer from inadequate filtrate flushing energy and cleaning action upon the filtration surfaces of the disks.

In response to unacceptable cleaning performance, further developments of the art have been advanced. Developments have been cited in which the total filtrate back flush flow is delivered in the form of one or more high velocity flows focused over relatively small areas of the filtration disk surfaces. As a consequence of the limited area of focused filtrate flushing, the high velocity flows and/or the cylindrical disk stack are mechanically maneuvered, relative to each other, so as to facilitate cleaning of the entire filtration surface.

In several of these embodiments the focused back flushing flow is generated by a drafting or suction type of action across the filtration surfaces. To facilitate this action the filter environs, comprising a housing and the associated enclosed disk stack, are maintained at a pressure elevated above that of an external waste back flush fluid manifold. A hollow, open ended conduit tube or slot, which is in hydraulic communication with the waste back flush manifold, is perpendicularly juxtaposed against a relatively small upstream area of the filter disk stack. In response to the pressure differential between the fluids constrained within the filter environs and the conduit tube, a converging fluid flow is induced past and through a relatively small and focused area of the disk stack and into the open end or slot of the conduit. This induced, relatively high velocity flow, dislodges cleans and conveys collected solid debris from the disk filtration surfaces to the waste back flush manifold for further processing or discharge. As a consequence of the limited area of focused flushing, the open end or slot of the conduit tube and/or the cylindrical disk stack are mechanically maneuvered, relative to each other, so as to facilitate cleaning of the entire filtration surface. Such embodiments have been cited to also include mechanisms for decompression of the disk stack. This action, as was previously recited, promotes access to the disk filtration surfaces to ameliorate the cleaning process. Examples delineating these lessons of the art are referenced as U.S. Pat. Nos. 4,042,504, 4,045,345, 4,271,018, 4,295,963, 4,906,373 and 4,923,601. A disadvantage associated with this example of the art is the volume of waste back flush fluid generated. The drafting action generates a convergence of flow from the filter environs. A portion of this fluid does not adequately contact the filtration surfaces to provide effective cleaning. As a result, there is excess fluid loss in the waste back flush volume. The flushing energy and cleaning action is also limited as a result of the relatively small pressure differential available to incite the fluid draft across the disk surfaces.

Other embodiments have been cited in which the total back flush flow is delivered in the form of one or more enhanced velocity flows presented as pressurized liquid jets focused over relatively small areas of the filtration disk surfaces. The cited embodiments have professed the high velocity jets in several formats, one being wherein high pressure flushing fluid is delivered from external of the filter to one or more movable jetting nozzles via an extendable and rotatable conduit. In such embodiments, the filtration flow is typically in the direction of radially external to internal of the cylindrical disk stack. The jet nozzles are located within the hollow center of the stack and are so oriented as to facilitate a jetting direction radially outwards through the stack. Axial extraction of the conduit and attached nozzles through the disk stack, while concurrently rotating the jetting nozzles about a plane coplanar with the disk surfaces, facilitates full flushing of the disk stack. Such embodiments have been cited to also include mechanisms for decompression of the disk stack. This action, as was previously recited, promotes access to the disk filtration surfaces to ameliorate the cleaning process. Examples of such embodiments can be referenced as U.S. Pat. Nos. 4,308,142, 4,655,910, 4,655,911, 4,906,357, 5,393,423 and 6,318,563. The modifications manifest within these cited examples improve the filtration performance on some industrial applications, though problems with disk plugging still exist within many industrial applications. The liquid flushing jets, though potentially higher in velocity than the previous embodiments, still do not maintain sufficient energy and cleaning activity to provide adequate cleaning in many industrial circumstances.

Another cited format of the embodiment of localized, high velocity jets employs the delivery of high pressure flushing fluid from external of the filter to a full circle nozzle assembly via an extendable conduit tube. In such an embodiment the back flush jet is presented as a relatively thin planar jet impacting in a radial format internal to the disk stack. To facilitate full coverage of the disk stack during the flushing operation, the circular nozzle assembly and associated conduit are extracted axially through the stack concurrent with full circle, radial jetting of the back flush fluid through the disks. Such embodiments have been cited to also include mechanisms for decompression of the disk stack. This action, as was previously recited, promotes access to the disk filtration surfaces to ameliorate the cleaning process. Reference is made to U.S. Pat. No. 4,156,651. The modifications manifest within this embodiment improve the filtration performance on some industrial applications though problems with disk plugging still exist within many industrial applications. The liquid flushing jets, though potentially higher in velocity than the previous embodiments, still do not maintain sufficient energy and cleaning activity to provide adequate cleaning in many industrial applications.

A further embodiment of the art exhibits the flushing efficiency of the pressurized jet approach but eliminates the mechanical complexities associated with the movement thereof. In this development the filter disks circumscribe several hollow shaft like elements. These shafts are oriented in the axial direction of the disk stack and provide the lateral support necessary to maintain the cylindrical configuration of the stack. Oriented on one or more of these shafts is a series of unidirectional nozzle-like holes providing hydraulic communication between the hollow interior and the exterior of the shafts. The hollow section of these shafts provide a conduit for reverse flow of filtrate. The nozzles provide the discharge means to jet the reverse flowing filtrate against the disks for back flush cleaning. These nozzle-holes are unidirectional on each tube and are located adjacent to, but in a somewhat tangential manner, to the internal surface of the disk stack. Said tangential orientation being similar so as to provide a vigorous rotational impetus to the disks. The upper ends of the shafts support a disk compression assembly. This assembly maintains closure pressure on the disk stack during filtration but moves in an axial direction away from the disk stack to release and open the disks for enhanced cleaning during back flushing. The lower ends of the shafts terminate in a support base in such a manner that the hollow of the shafts are in hydraulic communication with the filtrate porting of the disk stack. Included is a check valve assembly hydraulically located intermediate between the filtrate port of the disk stack and the open lower ends of the hollow shafts. This check valve provides the diversionary means necessary to direct the reverse filtrate flow into the hollow shaft elements and associated nozzles rather than into the internal volume of the disk stack. Reference is made to U.S. Pat. Nos. 4,655,910 and 4,655,911. The performance of this embodiment of the prior art shows some improvement over the previous lessons of the art though in many industrial applications it still suffers from inadequate filtrate back flushing energy and cleaning action upon the solids laden filtration disk surfaces.

In a co-pending patent by the inventor, there is presented an embodiment wherein the filter disks circumscribe several hollow shaft like elements. These shafts are oriented in the axial direction of the disk stack and provide the lateral support necessary to maintain the cylindrical configuration of the stack. Oriented on one or more of these shafts is a plurality of sets of nozzle-like holes wherein the nozzles of each set are individually oriented in substantially opposing directions. These nozzles provide hydraulic communication between the hollow interior and the exterior of the shafts. The hollow section of these shafts provide a conduit for a flow of cleaning medium from a back flush receiving plenum volume of the filter. Cleaning medium is expelled from these jets and impacts in a cleansing fashion across the filtration surfaces of the disks. The upper ends of the hollow shafts support a disk compression assembly. This assembly maintains closure pressure on the disk stack during filtration but moves in an axial direction away from the disk stack to release and open the disks for enhanced cleaning. The lower ends of the shafts pass in a sealed fashion through a filtrate plenum area and terminate in a support base in such a manner that the hollow of the shafts is in hydraulic communication with the back flush receiving plenum volume of the filter.

This embodiment of the art provides substantially improved cleaning performance as a result of the multi-directional nozzle orientations, reduced pressure drop by elimination of the check valve and the ability to employ an exterior, higher pressure, source of cleaning media. A disadvantage in this embodiment is the requirement for a valve to control the inlet of fluid into the back flush receiving plenum. This valve must be of sufficient size to accommodate the high flow rates required for efficient flushing and cleaning of the disks. As a consequence, the size and cost of this valve is substantial. Further, if chemicals are employed in the flushing fluid, the valve will need to be fabricated of a material not effected by the chemicals. This requirement further adds substantially to the cost of the valve.

The back flush cleaning procedures of the prior art have generally employed filtrate for back flushing operation. For those applications in which the available filtrate is of insufficient pressure, external pressurized filtrate or water back flush sources have been employed. Applications in practice have employed municipal water, pump pressurized filtrate and compressed air sources in an air over water approach to develop sufficiently high pressure for flushing. Though improving the overall performance, frictional pressure losses internal to the filters as well as throttling losses through flush nozzles dramatically reduces the available cleaning energy exerted upon the solids laden disk filtration surfaces. As a consequence, in many industrial applications, the employment of these alternative high pressure back flushing processes is still insufficient to provide satisfactory cleaning of the filtration surfaces.

A further disadvantage in the prior art relates to the inability to readily employ chemicals beneficial for cleaning of the filtration disks. Often in industrial applications, solids adhere to the disks with such tenacity that chemicals must be employed to adequately clean the filtration disks. In order to facilitate such cleaning, the filters of the prior art must be dismantled and the disks removed and chemically washed. This is a labor intensive, time consuming and inefficient process.

Industrial applications often result in a buildup of solids upon the filtration disk surfaces which require elevated temperatures for effective cleaning. A disadvantage of the prior art is that there are no provisions to facilitate flushing of the filtration disks at elevated temperatures. Those industrial applications in which elevated temperatures are necessary for adequate filtration disk cleaning require dismantling of the filters and removal and washing of the filtration disks at an elevated temperature. This is a labor intensive, time consuming and inefficient process.

In a similar fashion, there are many industrial applications wherein the only method for successful cleansing of the filtration disks requires cleaning with chemicals at an elevated temperature. The prior art teaches no options for this procedure other than dismantling of the filter, removal and elevated temperature chemical cleaning of the filtration disks. This is a labor intensive, time consuming and inefficient process.

Another disadvantage of the prior art is biotic plugging and fouling of the filtration disks. This problem arises from biological growth developing on the filtration disk surfaces. This common problem presents a substantial impediment to cleaning of the filtration disks. Further, the problem continues even after apparently successful flushing as a consequence of the regrowth of residual biotic cultures remaining on the disks. There are no methods taught by the prior art to resolve these problem other than dismantling of the filter, removal, cleaning and sterilization of the disks and any other effected internal structures by chemical, thermal or combined means. This is a labor intensive, time consuming, costly and inefficient process.

### OBJECTS AND ADVANTAGES

The goal of this invention is to provide resolution to the fundamental deficiencies inherent in the prior art which particularly affects the back flush cleansing, and thereby exploitation, of disk filtration processes in industry. Further, as an attendant benefit, the invention will provide an improved disk filtration process for agricultural applications.

An object of this invention is to afford a means to eliminate the requirement for the expensive and troublesome high volume back flush valves which are employed in the most efficient high pressure, outside source, back flushing embodiments of the prior art. These valves are necessary but prove to be expensive as well as being prone to chemical damage in the presence of aggressive disk cleaning chemicals. An object of this invention is to eliminate the expense of this valve, improve reliability and permit unimpeded employment of aggressive chemicals to improve the filtration disk cleansing efficiency. An advantage provided within this objective is the reduction in the capital cost of the filtration device. An additional advantage is the capability to employ aggressive chemicals without concern of damage to the back flush inlet valve. A further advantage is an improvement of the filtration device reliability due to the elimination of the failure prone back flush fluid inlet valve. Additionally, maintenance efforts, and therefore labor costs as well as process downtime, are reduced as a further consequence of the elimination of the maintenance intensive high volume back flush valve.

A further object of the invention is to provide a means to maintain high pressure in the back flush fluid as it passes through the filter internals and back flush cleaning nozzles. Such high pressure maintenance assures the maximum jetting and cleansing action of the back flush fluid as it impacts and scours the disk surfaces. The advantage provided through achievement of this objective is improved cleaning efficiency of the disks. With improved cleaning efficiency the back flushing frequency is reduced. Reduction of the back flush frequency affords abatement of wear and tear on the filtration equipment, reduction of the back flush waste volume and improved filtration throughput. Further, with improved cleansing efficiency, the labor, expense and downtime associated with disassembly, removal and manual cleaning of the filtration disks can be substantially reduced or eliminated. As a further advantage, the ability to maintain substantially higher pressure during cleansing of the disks affords the application of disk filtration technology to many industrial applications in which the disk filtration embodiments of the prior art cannot serve.

A further object of the invention is to provide a means to readily employ chemicals for enhancement of the disk cleaning process. Attainment of this objective facilitates the advantageous use of aggressive chemicals without the danger of damage to the filter internals. These chemicals enhance the disk cleansing efficiency thereby providing for reduced back flushing frequency. Reduced back flushing frequency is advantageous in reducing wear and tear on the filtration equipment, reducing back flush waste volume and improving filtration throughput. Further, with improved cleaning efficiency, the labor, expense and process downtime associated with disassembly, removal and manual cleaning of the filtration disks can be substantially reduced or eliminated. As a further advantage, the ability to employ chemical cleaning affords the application of disk filtration technology to many industrial applications for which the disk filtration embodiments of the prior art cannot serve.

An additional object of the invention is to provide a means to facilitate back flush cleansing of the filtration disks at an elevated temperature. The advantages inherent to this goal are dramatic improvement in the cleaning efficiency of the filtration disks in those applications in which elevated temperatures are necessary for adequate cleaning. The invention affords the advantage of employing elevated temperatures to promote enhanced cleansing of the disks. Consequently, expenses otherwise associated with the labor and process downtime accompanying the disassembly, removal and manual cleaning of the filtration disks of the prior art, can be substantially reduced or eliminated. A further advantage of the invention is in affording the employment of disk filtration processes to those industrial applications in which the embodiments of the prior art cannot be employed because of the adherence of solids to the disks; solids, which can only be removed by flushing at elevated temperatures.

An additional object of the invention is to provide a means to facilitate chemically enhanced back flushing at elevated temperatures. The advantages inherent to this objective are dramatic improvement in the back flush cleansing efficiency of the filtration disks for those applications wherein both chemicals and elevated temperatures are necessary to adequately clean the disks. The invention affords the advantage of employing both chemicals and elevated temperatures to facilitate enhanced cleaning of the disks. Consequently, expenses otherwise associated with the labor and process downtime accompanying the disassembly, removal and manual cleaning of the filtration disks of the prior art, can be substantially reduced or eliminated. A further advantage of the invention is in affording the use of disk filtration processes to those applications in which disk filtration, as taught in the prior art, cannot be employed due to plugging with solids which can only be removed through the employment of chemicals at elevated temperatures.

An additional object of the invention is to provide a means to chemically eliminate biotic fouling and plugging of the disks. Implementation of this objective provides a means to facilitate both cleaning of the filtration disks of organic as well as other materials and to further provide for sterilization of the filter disks and other filter internals. Sterilization reduces the tendency for future biotic fouling. The invention provides a unique and advantageous option to chemically sterilize by inclusion of the appropriate chemicals in the back flush fluid. This affords concurrent cleaning and sterilization of the disks thereby reducing the back flushing frequency. Reduced back flush frequency is advantageous in curtailing wear and tear on the filtration equipment, minimizing back flush waste volume and improving filtration throughput. Further, with chemical sterilization eliminating biotic solids build-up, expenses, otherwise associated with the labor and downtime accompanying the disassembly, removal and manual cleaning of the filtration disks of the prior art, can be substantially reduced or eliminated. Additionally, the invention makes available the beneficial use of disk filtration processes to those industrial applications in which biotic fouling precludes the use of the prior art.

A further object of the invention is to provide a means to thermally eliminate biotic fouling and plugging of the disks. Implementation of this objective provides a means to facilitate both cleaning of the filtration disks of biotic as well as other materials and to further provide for sterilization of the filter disks and other filter unit internals. Sterilization reduces the tendency for future biotic fouling. The invention provides an advantageous option to thermally sterilize by back flushing with fluids at an elevated temperature. Wherein the elevated temperature destroys residual biotic cultures on the disks or other internal components of the filter unit. This advantage promotes concurrent cleansing and sterilization of the disks, thereby reducing the back flushing frequency. Reduction of the back flush frequency is advantageous in reducing wear and tear on the filtration equipment, minimizing back flush waste volume and improving filtration throughput. Further, with thermal sterilization eliminating biotic solids build-up, the labor, expense and downtime associated with disassembly, removal and manual cleaning of the filtration disks can be eliminated or at least substantially reduced. Additionally, the invention makes available the beneficial use of disk filtration processes to those industrial applications in which biotic fouling precludes the use of the disk filtration embodiments of the prior art.

An additional object of the invention is to provide a means to afford a modular filtration unit configuration focused upon reducing fabrication time, effort and expense. The present art implements filtration system design through the custom fabrication of manifolds for hydraulically combining multiple filtration units together. These systems thereby consist of multiple filtration units with common manifolds and a common back flush system valved to service each of the filtration units individually. Accordingly, the manifolds and back flush system are custom configured for each individual application. Modifications resulting from feed fluid quality changes, changes in the required filtration flow rates or changes in the required filtrate quality, often demand major and expensive alterations to such systems. Such alterations usually require significant modification or re-manufacture of the inlet, outlet and back flush system manifolds. The inclusion of a reaction chamber as an integral part of each filter element, substantially simplifies system fabrication. The combined filter and reaction chamber modules can be provided as a single unit. These units are capable of being direct connected together, eliminating the necessity for custom manifold fabrication. Further, because of the inclusion of the reaction chamber as a back flush system integral to each filter unit, the application specific back flush system of the prior art is eliminated. The advantageous effect is to provide the capacity to directly connect the combined filtration and reaction chamber units together in either a parallel or series configuration to expedite fabrication of the filtration system as a whole. Custom manifolds and back flush systems are not required. System modifications simply require the addition or removal of the individual combined filtration and reaction chamber units. Such modifications being simple and readily performed on both new and existing installations. Further, system fabrication no longer requires expensive custom manifold fabrication, but rather, the maintenance of a simple inventory of the combined filtration and reaction chambers so as to facilitate assembly, rather than manufacture, on an as needed basis.

### DRAWING FIGURES

FIG. 30a is a top perspective view of the preferred embodiment of the invention, shown in filtration operation, in accompaniment with the preferred embodiment of a filter unit of a co-pending patent of the inventor. The figure demonstrates the present invention as attached to the filtrate end of the co-pending filter unit. Hollow, structural disk support tubes, of the co-pending invention, onto which back flush nozzle sets are provided on the upper section, extend, as an item of the present invention, into a reaction chamber of the present invention. During filtration, these tubes provide filtrate conveyance from the internal volume of the disk stack into the reaction chamber of the invention. Accordingly, while in the filtration mode, this reaction chamber fills with filtrate. Air or gas entrained within the reaction chamber is vented via a conduit from the reaction chamber. Compressed air or gas is not provided to an affiliated port adapted into the reaction chamber while operating in the filtration mode. During filtration, staged between back flushes, chemicals and/or heat may be supplied to the fluid residing in the reaction chamber. Sensors are active to control and maintain the proper concentration of chemicals and temperature of the fluid in the reaction chamber so as to assure optimum back flushing characteristics to efficiently clean the filter disks. The reader should note in this preferred embodiment, the presence of orifice passing from the reaction chamber into the back flush conveyance tubes proximate to the upper section of the reaction chamber.

FIG. 30b is a bottom perspective view of the preferred embodiment of the invention, shown in filtration operation, in accompaniment with the preferred embodiment of a filter unit of a co-pending patent of the inventor. The figure demonstrates the present invention as attached to the filtrate end of the co-pending filter unit. Hollow, structural disk support tubes, of the co-pending invention onto which back flush nozzle sets are provided on the upper section, extend, as an item of the present invention, into a reaction chamber of the present invention. During filtration, these tubes provide filtrate conveyance from the internal volume of the disk stack into the reaction chamber of the invention. Accordingly, while in the filtration mode, this reaction chamber fills with filtrate. Air or gas entrained within the reaction chamber is vented via a conduit from the reaction chamber. Compressed air or gas is not provided to an affiliated port adapted into the reaction chamber while operating in the filtration mode. During filtration, staged between back flushes, chemicals and/or heat may be supplied to the fluid residing in the reaction chamber. Sensors are active to control and maintain the proper concentration of chemicals and temperature of the fluid in the reaction chamber so as to assure optimum back flushing characteristics to efficiently clean the filter disks. The reader should note in this preferred embodiment, the presence of orifice passing from the reaction chamber into the back flush conveyance tubes proximate to the upper section of the reaction chamber.

FIG. 30c is a top perspective view of the preferred embodiment operating in the back flushing mode in accompaniment with the preferred embodiment of a filter unit of a co-pending patent of the inventor. The figure demonstrates the invention as attached to the filtrate end of said filter unit. Hollow structural disk support tubes are provided by the co-pending patent, onto which back flush nozzle sets are included in the upper section, extend, as items of the present invention, into a reaction chamber of the present invention for back flush conveyance. These tubes provide back flushing conveyance between the reaction chamber and the internal volume of the disk stack of the co-pending filter unit. During the back flushing operation, high pressure air or gas is forced via an air or gas inlet port into the upper area of the reaction chamber. This air or gas drives the back flushing fluid, which may be chemically treated and/or heated, downward in the reaction chamber and into the bottom inlet of the back flush conveyance tubes. This pressurized fluid is driven upward through the hollow of the tubes, past orifice in the tubes proximate to the upper section of the reaction chamber and into the filter assembly, thereby facilitating back flushing of the filter disks. A fraction of the high pressure air or gas bleeds through the orifice holes on the hollow back flush conveying tubes, proximate to the upper end of the reaction chamber, atomizing into and becoming entrained therein to the back flush fluid as it is conveyed unto the filter for the back flushing process.

FIG. 30d is a bottom perspective view of the preferred embodiment operating in the back flushing mode in accompaniment with the preferred embodiment of a filter unit of a co-pending patent of the inventor. The figure demonstrates the invention as attached to the filtrate end of said filter unit. Hollow structural disk support tubes are provided by the co-pending patent, onto which back flush nozzle sets are included in the upper section, extend, as items of the present invention, into a reaction chamber of the present invention for back flush conveyance. These tubes provide back flushing conveyance between the reaction chamber and the internal volume of the disk stack of the co-pending filter unit. During the back flushing operation, high pressure air or gas is forced via an air or gas inlet port into the upper area of the reaction chamber. This air or gas drives the back flushing fluid, which may be chemically treated and/or heated, downward in the reaction chamber and into the bottom inlet of the back flush conveyance tubes. This pressurized fluid is driven upward through the hollow of the tubes, past orifice in the tubes proximate to the upper section of the reaction chamber and into the filter assembly, thereby facilitating back flushing of the filter disks. A fraction of the high pressure air or gas bleeds through the orifice holes on the hollow back flush conveying tubes, proximate to the upper end of the reaction chamber, atomizing into and becoming entrained therein to the back flush fluid as it is conveyed unto the filter for the back flushing process.

FIG. 32a is a top perspective view of an embodiment of the subject invention attached to a horizontal application of a filter unit of a co-pending patent of the inventor. In this figure, the invention and attached filter unit are operating in the filtration mode. Note that the mechanisms, as illustrated in this figure, are essentially identical to that of FIG. 30a with the exception being that the filter apparatus has been oriented in a horizontal fashion.

FIG. 32b is a top perspective view of an embodiment of the subject invention attached to a horizontal application of a filter unit of a co-pending patent of the inventor. In this figure, the invention and attached filter apparatus are operating in the back flushing mode. Note that the mechanisms, as illustrated in this figure, are essentially identical to that of FIG. 30c with the exception being that the filter apparatus has been oriented in a horizontal fashion.

FIG. 34a is a top perspective view of an embodiment of the subject invention attached to horizontal, dually opposed, applications of filter units of a co-pending patent of the inventor. In this figure, the invention and the dual, horizontally opposed filtration mechanisms are operating in the filtration mode. Note that the mechanisms, as illustrated in this figure, are essentially identical to that of FIG. 30a with the exception being that the filter units have been oriented in a horizontal fashion and the inclusion of an additional filtration unit being serviced by the subject invention. In this embodiment, the reaction chamber and associated components are increased in size so as to service both of the filtration units.

FIG. 34b is a top perspective view of an embodiment of the subject invention attached to horizontal, dually opposed, applications of filter units of a co-pending patent of the inventor. In this figure, the invention and the dual, horizontally opposed filtration units are operating in the back flushing mode. Note that the mechanisms, as illustrated in this figure, are essentially identical to that of FIG. 30c with the exception being that the filter units have been oriented in a horizontal fashion and with the inclusion of an additional filtration unit being serviced by the subject invention. In this embodiment, the reaction chamber and associated components are increased in size so as to service both of the filtration units.

FIG. 36a is a top perspective view of the preferred embodiment of the invention, shown in filtration operation, in accompaniment with the preferred embodiment of a filter unit of a co-pending patent of the inventor. The figure demonstrates the present invention as attached to the filtrate end of the co-pending filter unit. Hollow, structural disk support tubes, of the co-pending invention, onto which back flush nozzle sets are provided on the upper section, extend, as an item of the present invention, into a reaction chamber of the present invention. During filtration, these tubes provide filtrate conveyance from the internal volume of the disk stack into the reaction chamber of the invention. Accordingly, while in the filtration mode, this reaction chamber fills with filtrate. Air or gas entrained within the reaction chamber is vented via a conduit from the reaction chamber. High pressure fluid is not provided to an affiliated port adapted into the reaction chamber while operating in the filtration mode. During filtration, staged between back flushes, chemicals and/or heat may be supplied to the fluid residing in the reaction chamber. Sensors are active to control and maintain the proper concentration of chemicals and temperature of the fluid in the reaction chamber so as to assure optimum back flushing characteristics to efficiently clean the filter disks.

FIG. 36b is a bottom perspective view of the preferred embodiment of the invention, shown in filtration operation, in accompaniment with the preferred embodiment of a filter unit of a co-pending patent of the inventor. The figure demonstrates the present invention as attached to the filtrate end of the co-pending filter unit. Hollow, structural disk support tubes, of the co-pending invention onto which back flush nozzle sets are provided on the upper section, extend, as an item of the present invention, into a reaction chamber of the present invention. During filtration, these tubes provide filtrate conveyance from the internal volume of the disk stack into the reaction chamber of the invention. Accordingly, while in the filtration mode, this reaction chamber fills with filtrate. Air or gas entrained within the reaction chamber is vented via a conduit from the reaction chamber. High pressure fluid is not provided to an affiliated port adapted into the reaction chamber while operating in the filtration mode. During filtration, staged between back flushes, chemicals and/or heat may be supplied to the fluid residing in the reaction chamber. Sensors are active to control and maintain the proper concentration of chemicals and temperature of the fluid in the reaction chamber so as to assure optimum back flushing characteristics to efficiently clean the filter disks.

FIG. 36c is a top perspective view of the preferred embodiment operating in the back flushing mode in accompaniment with the preferred embodiment of a filter unit of a co-pending patent of the inventor. The figure demonstrates the invention as attached to the filtrate end of said filter unit. Hollow structural disk support tubes are provided by the co-pending patent, onto which back flush nozzle sets are included in the upper section, extend, as items of the present invention, into a reaction chamber of the present invention for back flush conveyance. These tubes provide back flushing conveyance between the reaction chamber and the internal volume of the disk stack of the co-pending filter unit. During the back flushing operation, high pressure fluid, from a source external to the apparatus, is forced, via an inlet port, into the upper area of the reaction chamber. This high pressure fluid drives the back flushing fluid, which may be chemically treated and/or heated, downward in the reaction chamber and into the bottom inlet of the back flush conveyance tubes. This pressurized fluid is further driven upward through the hollow of the tubes, and into the filter assembly, thereby facilitating back flushing of the filter disks.

FIG. 36d is a bottom perspective view of the preferred embodiment operating in the back flushing mode in accompaniment with the preferred embodiment of a filter unit of a co-pending patent of the inventor. The figure demonstrates the invention as attached to the filtrate end of said filter unit. Hollow structural disk support tubes are provided by the co-pending patent, onto which back flush nozzle sets are included in the upper section, extend, as items of the present invention, into a reaction chamber of the present invention for back flush conveyance. These tubes provide back flushing conveyance between the reaction chamber and the internal volume of the disk stack of the co-pending filter unit. During the back flushing operation, high pressure fluid, from a source external to the apparatus, is forced, via an inlet port, into the upper area of the reaction chamber. This high pressure fluid drives the back flushing fluid, which may be chemically treated and/or heated, downward in the reaction chamber and into the bottom inlet of the back flush conveyance tubes. This pressurized fluid is further driven upward through the hollow of the tubes, and into the filter assembly, thereby facilitating back flushing of the filter disks.

### REFERENCE NUMERALS IN THE DRAWING

1 Unfiltered fluid inlet to the filter unit

2 Outlet for waste from the filter unit

3 Inlet port to the filter unit

4 Plunger valve seat of the filter unit

5 Centrifugal inlet impeller of the filter unit

6 Sealing plunger of the filter unit

7 Disk filtration element set of the filter unit

8 Tubular support members of the filter unit and back flush conveyances of the invention

9 Right hand rotation oriented member of orifice set of the filter unit

9a Right hand rotation oriented member of spray set of the filter unit

10 Left hand rotation oriented member of orifice set of the filter unit

10a Left hand rotation oriented member of spray set of the filter unit

11 Disk filtration stack filtrate port of the filter unit

14 Filtrate product outlet of the filter unit

15 Filter body of the filter unit

16 Filtrate plenum of the filter unit

17 Tubular support base of the filter unit

18 Seal of the filter unit

19 Back flush discharge plenum of the filter unit

20 Connecting shaft of the filter unit

21 Filtrate valve assembly of the filter unit

22 Disk filter stack support base of the filter unit

25 Reaction chamber body of the invention

26 Open lower end of the back flush outlet conveyances of the invention

27 Air or gas reaction orifice of the invention

28 Compressed air or gas inlet of the invention

29 Air or gas vent of the invention

30 Chemical feed port of the invention

31 Chemistry monitoring port of the invention

32 Heating element port of the invention

33 Thermostatically controlled heating element of the invention

34 Chemical sensor port of the invention

35 Reaction chamber of the invention

36 High pressure fluid inlet of the invention

### BRIEF SUMMARY OF THE INVENTION

Summarily, in accordance with the foregoing and other broad aspects of the invention, there is provided by the discussions of this patent an industrial grade filtration back flush support apparatus wherein, by means of a unique and novel, reaction chamber concept and design, back flushing of filter elements, especially those elements employing filtration disks can be substantially improved. This dramatic improvement is afforded through the novel inclusion of a filtrate receiving reaction chamber wherein chemical, thermal and mechanical processes serve to generate a far superior filter back flush cleaning process than is available in the prior art.

The invention employs a reaction chamber body into which filtrate is bled during the filtration mode of operation. In employ with the inventors co-pending filter unit, the filtrate enters the invention via leakage through a series of back flush spray nozzle orifice on one or more hollow disk stack support tubes located within the filtration disk stack and which extend as a back flush conveyance outlet into the present invention. The filtrate is conveyed via these tubes away from the filter and into a closed reaction chamber of the invention. These hollow tubes terminate in an open ended fashion near the lower end of the reaction chamber. The upper ends of these tubes pass from the filter through a support plate and into the reaction chamber in such a fashion that this support plate seals the upper end of the reaction chamber and provides a mechanical means of attachment of the reaction chamber to the filter. These tubes have additional orifice within the upper confines of the reaction chamber, adjacent to the sealing support plate.

An air or gas vent is provided in a port near the top of the reaction chamber to discharge residual air or gas, and thereby permitting complete filling of the reaction chamber with filtrate. Further, access ports into the reaction chamber are included to facilitate chemical feed and chemical monitoring of the fluid chemistry held within the reaction chamber. Additional ports are provided for inclusion of thermal control elements. These chemical feed, monitoring and thermal control ports provide the means to optimize the cleaning characteristics of the fluid held within the reaction chamber for use in back flushing the attached filter unit.

A compressed air or gas inlet port is provided in the upper end of the reaction chamber. Compressed air or gas is admitted into this port to facilitate back flushing operation. Back flushing is provided, by the introduction of compressed air or gas via the compressed air or gas inlet port, into the reaction chamber at the upper most area of the reaction chamber. The high pressure air or gas on top of the fluid forces the treated fluid down the reaction chamber and into and up the back flush conveyance tubes towards the attached filter unit. This pressurized fluid flows upward in the tubes and past the orifice in the tubes at the top of the reaction chamber. Compressed air or gas jets from the reaction chamber through these orifice and atomizes into the upward moving fluid stream, thereby entraining and energizing the back flush fluid with high pressure air or gas. The high pressure, energized, chemically and thermally treated back flush fluid is then conveyed to the attached filter unit to provide superior back flushing performance.

Further features and advantages of the invention will be apparent to those knowledgeable in the art by reference to the illustrations and associated elucidations supporting several embodiments of the art as follows.

FIGURE DESCRIPTIONS

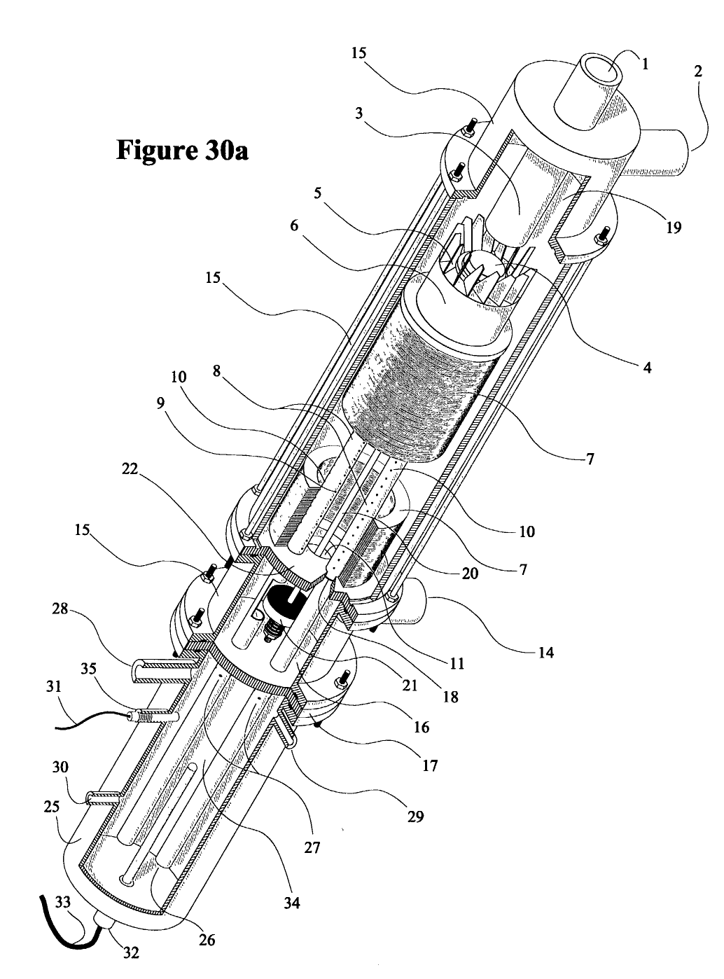

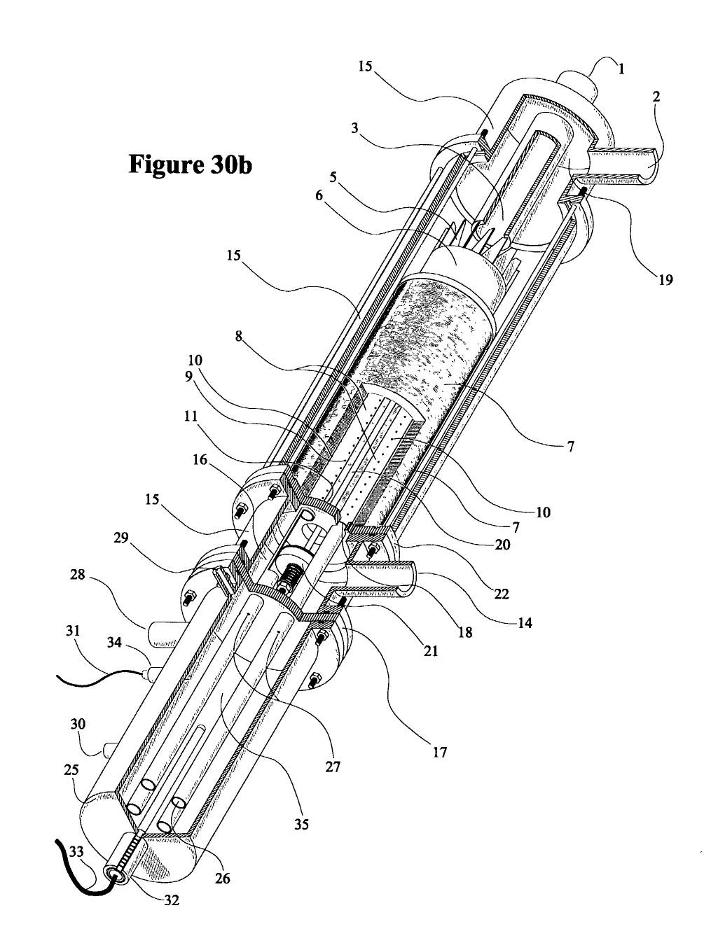

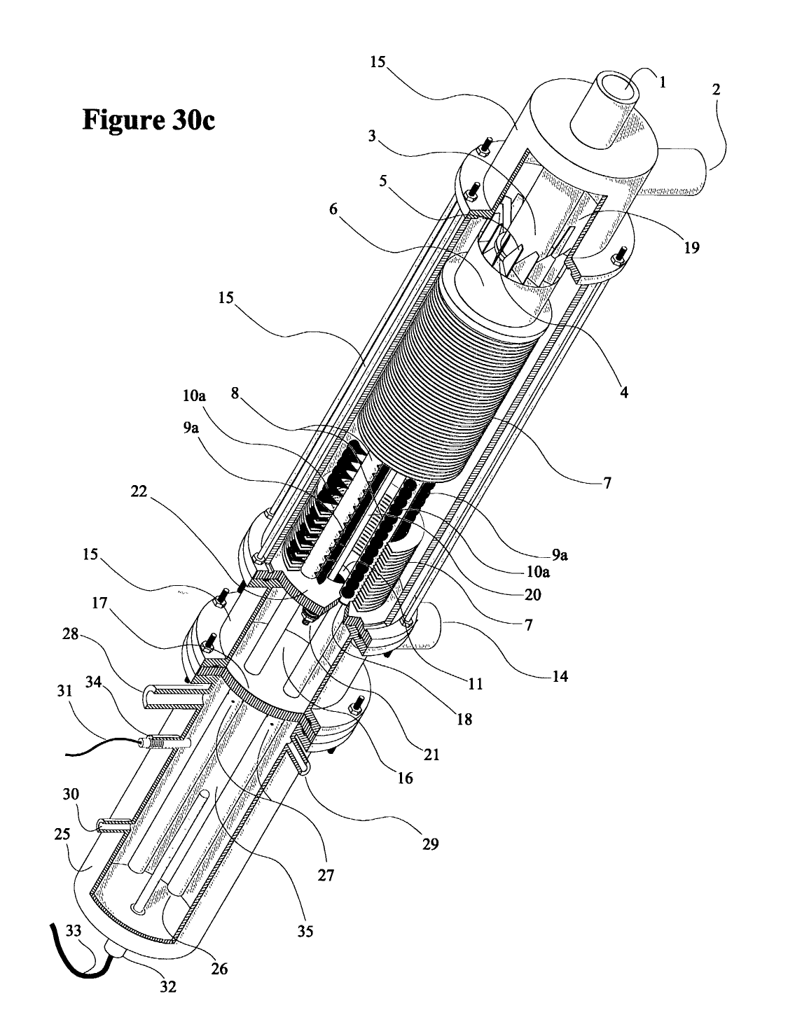

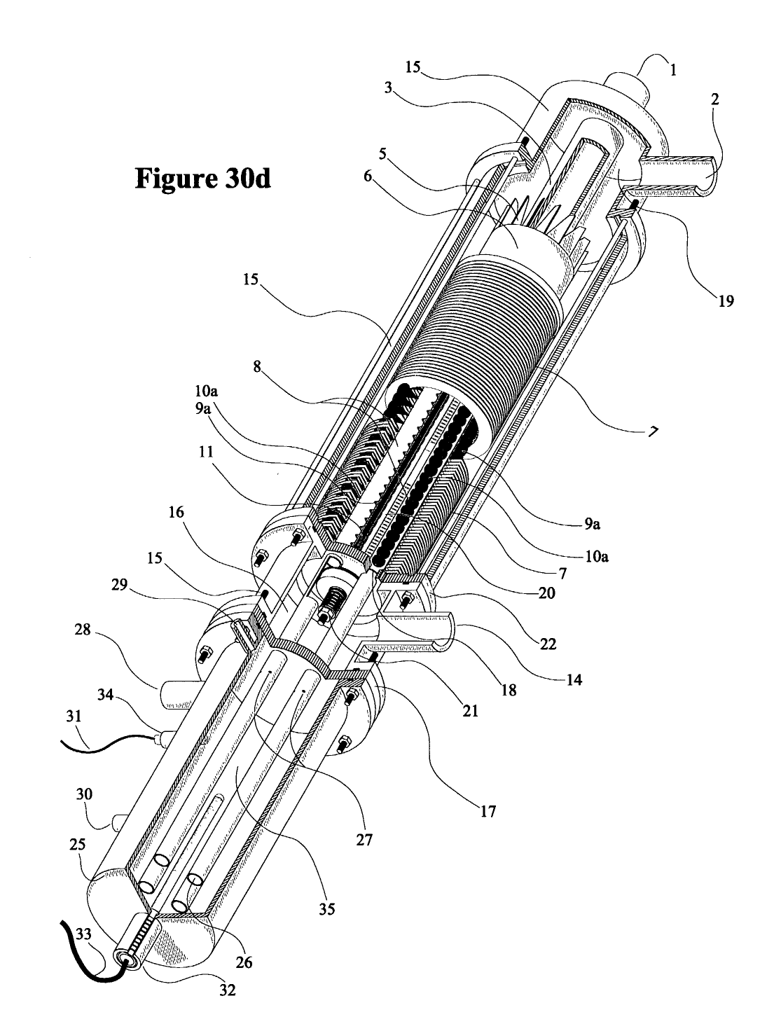

Description—FIGS. 30a and 30b

Direct to obtaining the effect of the invention, a preferred embodiment, operating in the filtration mode, is illustrated in perspective on FIG. 30a as an inclined to the upstream view and FIG. 30b as an inclined to the downstream view. The invention, as illustrated, is configured for back flush service to the filter unit of a co-pending patent of the inventor. Operational definition of the preferred embodiment is as follows.

Unfiltered fluid is introduced, under pressure, into a filter body 15 via inlet I of a filter unit. The unfiltered fluid travels through inlet port 3 and discharges from a valve seat receiver end of the inlet port 3 onto a inlet valve seat area 4 located on top of a sealing plunger 6. The unfiltered fluid impacts against the inlet valve seat area 4 and is impelled by the impact radially outward, acquiring a swirl while passing through turning vanes of a centrifugal inlet impeller 5.

The swirling, unfiltered fluid passes through an annular space between an interior surface of filter body 15 and external to the surface of filtration disks stack 7. The upstream end of the filtration disks 7 stack is sealed by the backside of a sealing plunger 6, being in the opened inlet, filtration mode position. The downstream end of the filtration disks 7 stack is sealed by a disk support base 22. The fluid passes between the filtration disks 7 of the stack and accedes to the internal volume of the filtration disks 7 stack as a filtrate. The majority of the filtrate exits the disks 7 via a filtrate discharge port 11 adjacent to a connecting shaft 20, past an open discharge valve 21 and enters a filtrate plenum 19 for transfer, via a filtrate discharge outlet 14, to process. A fraction of the filtrate transpires through orifice sets 9 and 10 and is conveyed, via hollow support tubes 8, through a support plate 17, downward into the present invention, via back flush conveyance tubes 8, and discharges from tubing outlets 26 into the lower section of a reaction chamber 35. Air or gas enclosed within the reaction chamber 35 is released through an air or gas vent port 29 as the reaction chamber 35 fills with filtrate. The air or gas vent 29 closes when the reaction chamber 35 is full. The chemistry of the filtrate contained within the reaction chamber 35 is monitored via a chemical sensor 31 located in sensor port 34. Chemicals necessary to achieve the optimum filter disk cleaning efficiency are injected into the reaction chamber 35 via chemical inlet port 30. The temperature of the filtrate necessary to achieve the optimum filter disk cleaning efficiency is controlled within the reaction chamber 35 by means of a thermostatically controlled heating element 33 inserted into the reaction chamber 35 via an insertion port 32.

Description—FIGS. 30c and 30d

Direct to obtaining the effect of the invention, a preferred embodiment, operating in the back flushing mode, is illustrated in perspective on FIG. 30c as an inclined to the upstream view and FIG. 30d as an inclined to the downstream view. The invention, as illustrated, is configured for back flush service to the filter unit of a co-pending patent of the inventor. Operational definition of the preferred embodiment is as follows.

During the back flushing operation high pressure compressed air or gas is introduced into a reaction chamber 35 of the present invention via an air or gas inlet port 28. Chemically and thermally treated filtrate fluid in the reaction chamber 35 is forced, under pressure, downward in the reaction chamber 35 and upward into the open lower ends 26 of back flush conveyance tubes 8. The pressurized fluid is continually forced upward in the conveyance tubes 8 as compressed air or gas, entering via the air or gas inlet port 28, continues to fill and displace fluid downward in the reaction chamber 35. High pressure air or gas in the upper section of the reaction chamber 35 transpires through reaction orifice 27 thereby atomizing into and becoming entrained within the treated filtrate as it is conveyed past the reaction orifice 27 and upwards into an attached filter unit. The high pressure, air or gas entrained, treated filtrate fluid is conveyed through a tubular support base 17, through a filtrate plenum chamber 19 and through a disk support base 22 and seal 18. The fluid initially passes orifice sets 9 and 10 and into a sealing plunger assembly 6. The pressure exerted by the fluid drives the sealing plunger 6 in the upstream direction compelling a plunger valve seat 4 onto a valve seat receiver end of the inlet port 3, effectively shutting off unfiltered water entering from supply 1. Concurrent with this action, the backside of the sealing plunger assembly 6 moves away from filtration disk 7 stack, thereby releasing compression of the disks 7 in the axial direction. Further, the motion of the sealing plunger assembly 6 draws tension upon a connecting shaft 20 pulling a filtrate valve assembly 21 in a sealing relationship to a receiver surface on the downstream side of a disk support base 17, thereby sealing the upstream side of the disk support base 17 from a filtrate plenum region 19. The pressurized fluid exits internal tubular support members 8 from paired orifice 9 and 10, thereby generating a plurality of air or gas entrained fluid jets 9a and 10a as coplanar, essentially equal velocity jets. These jets 9a and 10a impinge upon the released filter disks 7 and, as a consequence of the high pressure entrained air or gas, purvey a high pressure, pneumatically enhanced and maintained, hydraulic scouring and cleaning action upon the filter disk 7 surfaces. The back flush fluid jets 9a and 10a discharge across the filter disks 7 in nearly opposing directions with the entrained air or gas expanding and driving the treated filtrate back flushing fluid in an explosive fashion across the filter disk surfaces 7. As a consequence, debris adhering to the disk 7 surfaces is strongly impacted from different directions, thereby purveying a dramatically enhanced cleaning efficacy of the disks 7. Further, the slightly nonparallel opposite directions of jet fluids 9a and 10a generate slightly unequal drag forces across the disk 7 surfaces. The back flush fluid jet 9a ejected from orifice 9 tends to drag the filter disks 7 in a right handed rotational direction. The back flush fluid jet 10a ejected from orifice 10 tends to drag the filter disks 7 in a left handed rotational direction. As a consequence of the slight variance from opposite of the impact angles of the of the jets 9a and 10a upon the filter disks 7, a slight rotational motion is imparted to the disks 7. This motion, in concert with the two nearly opposite impact angles of jets 9a and 10a, assure an essentially full 180 degree aggressive scouring action across the filter disk 7 surfaces which delivers superior cleaning efficiency. The slight variance from opposite of the impact angles of the jets 9a and 10a is important to assure a slow rotational speed of the impacted disks 7. High rotational speed results in a detrimental variance of the relative velocity of impact between the jets 9a and 10a and the disks 7. The effect of this variance is a bias of the cleaning efficiency of the jets impacting the disk 7 surfaces in an oncoming fashion relative to that of the jets impacting the disk 7 surfaces in a retreating fashion. Such bias reduces the overall cleaning effectiveness of the disks 7.

Spent and solids laden back flush waste fluid and decompressed air or gas exits external to the back flushed disk 7 stack and is conveyed in an annular space between the external surface of the disk 7 stack and internal to filter body 15 to waste discharge plenum 19 and then to outlet 2 for discharge.

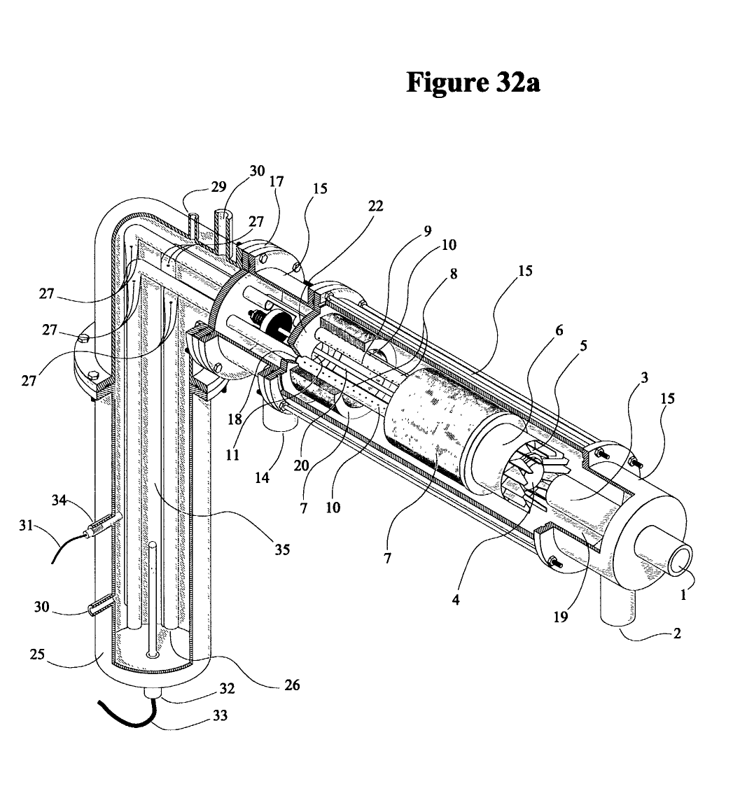

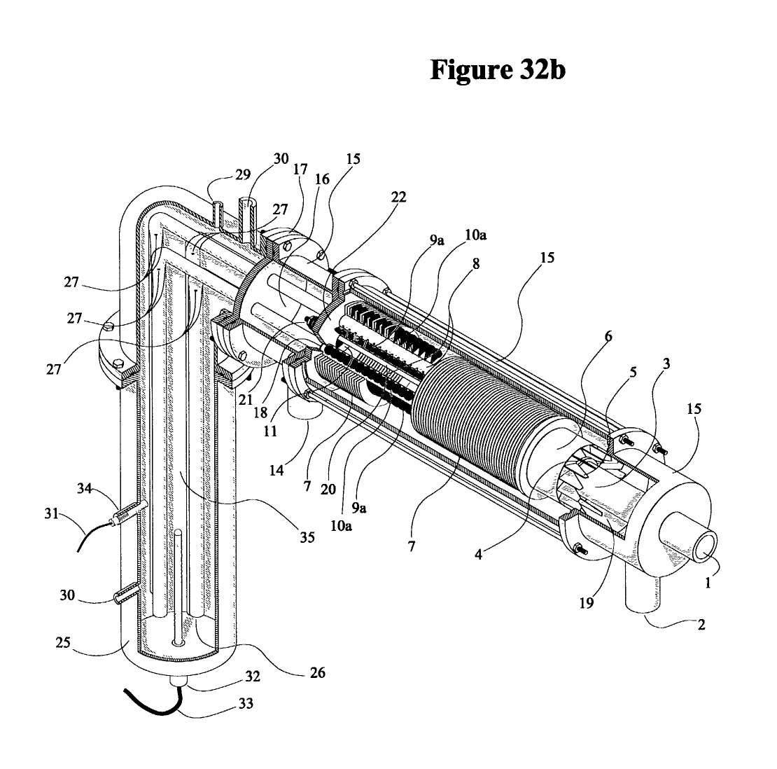

Description—FIG. 32a

Direct to obtaining the effect of the invention there is an embodiment, as illustrated on FIG. 32a, in which a filter unit and reaction chamber body of the present invention are oriented at right angles. The invention, as illustrated, is configured for back flush service to the filter unit of a co-pending patent of the inventor. Such an embodiment is useful to establish a horizontal orientation of the disk stack while maintaining a vertical orientation of the reaction chamber body. Horizontal orientation of the filter body is advantageous in some applications to facilitate distributed opening of a disk stack in the filter unit during back flushing. Such orientation is also helpful for the discharge of heavy particulate. A vertical orientation for the reaction chamber is advantageous to assure proper segregation and orientation of the compressed air or gas and treated filtrate in the reaction chamber during back flushing.

Unfiltered fluid is introduced, under pressure, into a filter body 15 via inlet I of a filter unit. The unfiltered fluid travels through inlet port 3 and discharges from a valve seat receiver end of the inlet port 3 onto a inlet valve seat area 4 located on top of a sealing plunger 6. The unfiltered fluid impacts against the inlet valve seat area 4 and is impelled by the impact radially outward, acquiring a swirl while passing through turning vanes of a centrifugal inlet impeller 5.

The swirling, unfiltered fluid passes through an annular space between an interior surface of filter body 15 and external to the surface of filtration disks stack 7. The upstream end of the filtration disks 7 stack is sealed by the backside of a sealing plunger 6, being in the opened inlet, filtration mode position. The downstream end of the filtration disks 7 stack is sealed by a disk support base 22. The fluid passes between the filtration disks 7 of the stack and accedes to the internal volume of the filtration disks 7 stack as a filtrate. The majority of the filtrate exits the disks 7 via a filtrate discharge port 11 adjacent to a connecting shaft 20, past an open discharge valve 21 and enters a filtrate plenum 19 for transfer, via a filtrate discharge outlet 14, to process. A fraction of the filtrate transpires through orifice sets 9 and 10 and is conveyed, via hollow support tubes 8, through a support plate 17, downward into the present invention, via back flush conveyance tubes 8, and discharges from tubing outlets 26 into the lower section of a reaction chamber 35. Air or gas enclosed within the reaction chamber 35 is released through an air or gas vent port 29 as the reaction chamber 35 fills with filtrate. The air or gas vent 29 closes when the reaction chamber 35 is full. The chemistry of the filtrate contained within the reaction chamber 35 is monitored via a chemical sensor 31 located in sensor port 34. Chemicals necessary to achieve the optimum filter disk cleaning efficiency are injected into the reaction chamber 35 via chemical inlet port 30. The temperature of the filtrate necessary to achieve the optimum filter disk cleaning efficiency is controlled within the reaction chamber 35 by means of a thermostatically controlled heating element 33 inserted into the reaction chamber 35 via an insertion port 32.

Description—FIG. 32b

Direct to obtaining the effect of the invention there is an embodiment previously illustrated operating in the filtration mode as FIG. 32a. FIG. 32b is included to illustrate this embodiment operating in the back flushing mode. The invention, as illustrated, is configured for back flush service to a filter unit of a co-pending patent of the inventor. Such an embodiment is useful to establish a horizontal orientation of the disk stack while maintaining a vertical orientation of the reaction chamber body. Horizontal orientation of the filter unit is advantageous in some applications to facilitate distributed opening of a filtration disk stack during back flushing. Such orientation is also helpful for the discharge of heavy particulate. A vertical orientation for the reaction chamber is advantageous to assure proper segregation and orientation of the compressed air or gas and treated filtrate in the reaction chamber during back flushing.

During the back flushing operation high pressure compressed air or gas is introduced into a reaction chamber 35 of the present invention via an air or gas inlet port 28. Chemically and thermally treated filtrate fluid in the reaction chamber 35 is forced, under pressure, downward in the reaction chamber 35 and upward into the open lower ends 26 of back flush conveyance tubes 8. The pressurized fluid is continually forced upward in the conveyance tubes 8 as compressed air or gas, entering via the air or gas inlet port 28, continues to fill and displace fluid downward in the reaction chamber 35. High pressure air or gas in the upper section of the reaction chamber 35 transpires through reaction orifice 27 thereby atomizing into and becoming entrained within the treated filtrate as it is conveyed past the reaction orifice 27 and upwards into an attached filter unit. The high pressure, air or gas entrained, treated filtrate fluid is conveyed through a tubular support base 17, through a filtrate plenum chamber 19 and through a disk support base 22 and seal 18. The fluid initially passes orifice sets 9 and 10 and into a sealing plunger assembly 6. The pressure exerted by the fluid drives the sealing plunger 6 in the upstream direction compelling a plunger valve seat 4 onto a valve seat receiver end of the inlet port 3, effectively shutting off unfiltered water entering from supply 1. Concurrent with this action, the backside of the sealing plunger assembly 6 moves away from filtration disk 7 stack, thereby releasing compression of the disks 7 in the axial direction. Further, the motion of the sealing plunger assembly 6 draws tension upon a connecting shaft 20 pulling a filtrate valve assembly 21 in a sealing relationship to a receiver surface on the downstream side of a disk support base 17, thereby sealing the upstream side of the disk support base 17 from a filtrate plenum region 19. The pressurized fluid exits internal tubular support members 8 from paired orifice 9 and 10, thereby generating a plurality of air or gas entrained fluid jets 9a and 10a as coplanar, essentially equal velocity jets. These jets 9a and 10a impinge upon the released filter disks 7 and, as a consequence of the high pressure entrained air or gas, purvey a high pressure, pneumatically enhanced and maintained, hydraulic scouring and cleaning action upon the filter disk 7 surfaces. The back flush fluid jets 9a and 10a discharge across the filter disks 7 in nearly opposing directions with the entrained air or gas expanding and driving the treated filtrate back flushing fluid in an explosive fashion across the filter disk surfaces 7. As a consequence, debris adhering to the disk 7 surfaces is strongly impacted from different directions, thereby purveying a dramatically enhanced cleaning efficacy of the disks 7. Further, the slightly nonparallel opposite directions of jet fluids 9a and 10a generate slightly unequal drag forces across the disk 7 surfaces. The back flush fluid jet 9a ejected from orifice 9 tends to drag the filter disks 7 in a right handed rotational direction. The back flush fluid jet 10a ejected from orifice 10 tends to drag the filter disks 7 in a left handed rotational direction. As a consequence of the slight variance from opposite of the impact angles of the of the jets 9a and 10a upon the filter disks 7, a slight rotational motion is imparted to the disks 7. This motion, in concert with the two nearly opposite impact angles of jets 9a and 10a, assure an essentially full 180 degree aggressive scouring action across the filter disk 7 surfaces which delivers superior cleaning efficiency. The slight variance from opposite of the impact angles of the jets 9a and 10a is important to assure a slow rotational speed of the impacted disks 7. High rotational speed results in a detrimental variance of the relative velocity of impact between the jets 9a and 10a and the disks 7. The effect of this variance is a bias of the cleaning efficiency of the jets impacting the disk 7 surfaces in an oncoming fashion relative to that of the jets impacting the disk 7 surfaces in a retreating fashion. Such bias reduces the overall cleaning effectiveness of the disks 7.

Spent and solids laden back flush waste fluid and decompressed air or gas exits external to the back flushed disk 7 stack and is conveyed in an annular space between the external surface of the disk 7 stack and internal to filter body 15 to waste discharge plenum 19 and then to outlet 2 for discharge.

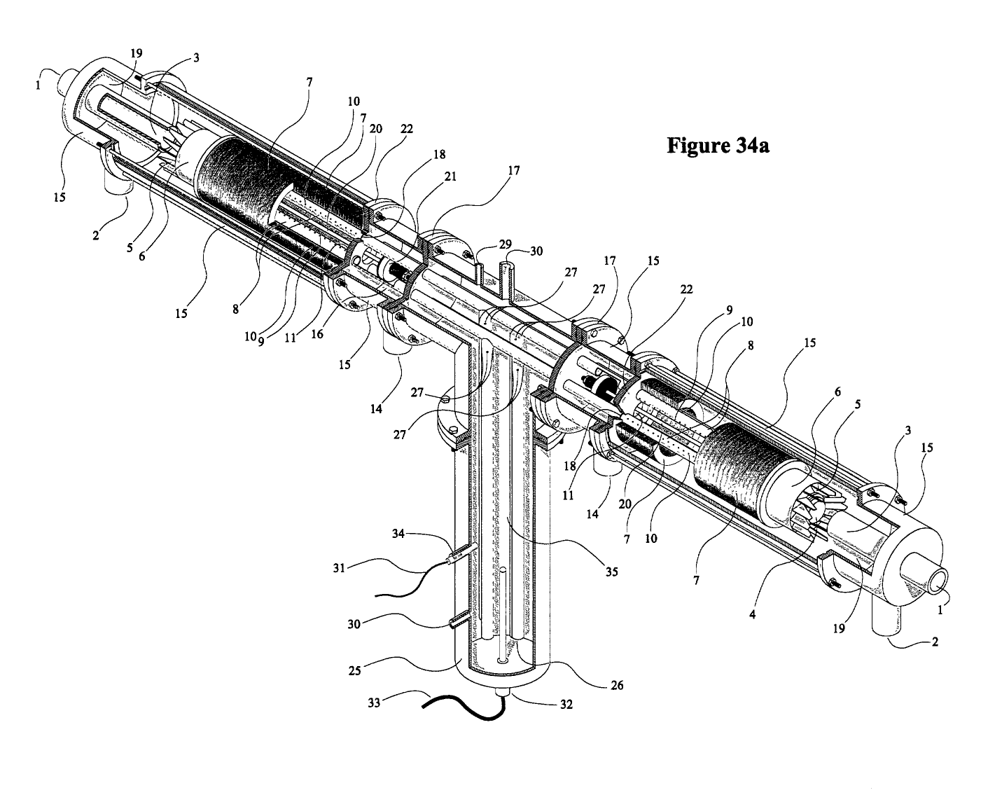

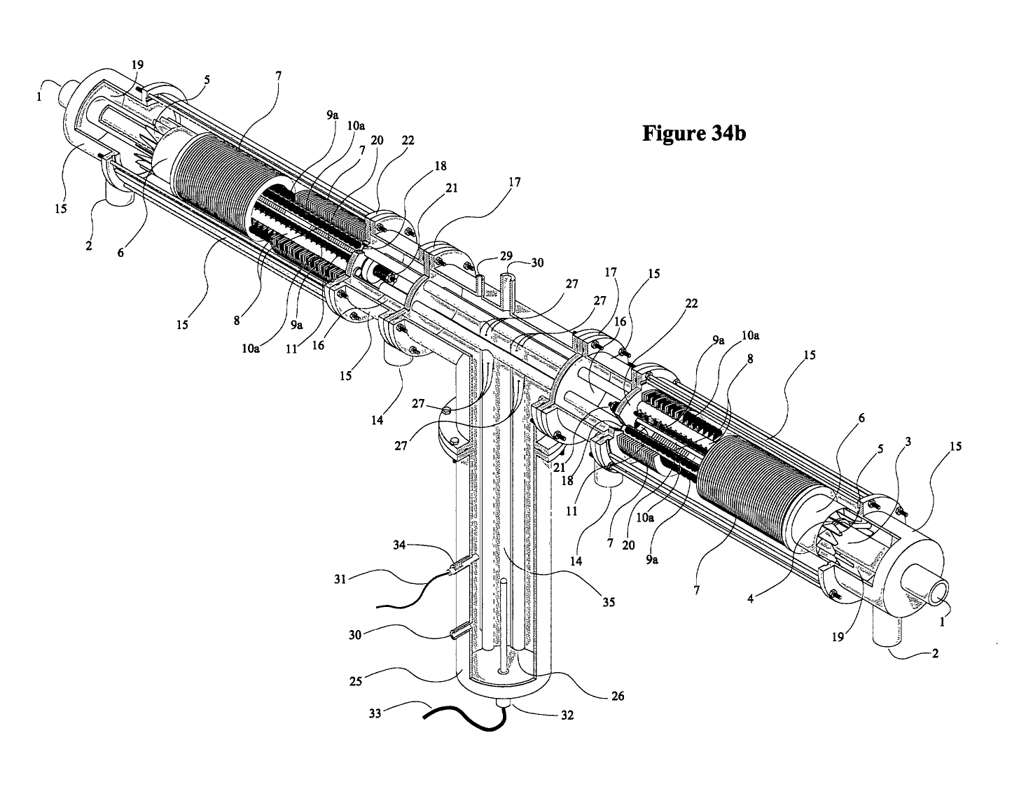

Description—FIG. 34a

Direct to obtaining the effect of the invention, there is an embodiment onto which twin filters are serviced by one reaction chamber device as cited herein with the primary modification of the present invention being of increased size, so as to service the additional filter. The invention, as illustrated, is configured for back flush service to dual filter units of a co-pending patent of the inventor. The embodiment so configured is illustrated as FIG. 34a. In practice, such an embodiment is preferential when spatial constraints exist. The referenced illustration of this embodiment also demonstrates the right angle orientation between the filters and the reaction chamber in a manner similar to the embodiment as illustrated on FIG. 32a. As was described for the embodiment illustrated on FIG. 32a, it is useful to establish a horizontal orientation of a disk stack in the filter units while maintaining a vertical orientation of the present invention reaction chamber body. Horizontal orientation of the filter body is advantageous in some applications to facilitate distributed opening of the disk stack during back flushing. Such orientation is also helpful for the discharge of heavy particulate. A vertical orientation for the reaction chamber is advantageous to assure proper segregation and orientation of compressed air or gas and treated filtrate in the reaction chamber during back flushing.

Unfiltered fluid is introduced, under pressure, into a filter body 15 via inlet I of a filter unit. The unfiltered fluid travels through inlet port 3 and discharges from a valve seat receiver end of the inlet port 3 onto a inlet valve seat area 4 located on top of a sealing plunger 6. The unfiltered fluid impacts against the inlet valve seat area 4 and is impelled by the impact radially outward, acquiring a swirl while passing through turning vanes of a centrifugal inlet impeller 5.

The swirling, unfiltered fluid passes through an annular space between an interior surface of filter body 15 and external to the surface of filtration disks stack 7. The upstream end of the filtration disks 7 stack is sealed by the backside of a sealing plunger 6, being in the opened inlet, filtration mode position. The downstream end of the filtration disks 7 stack is sealed by a disk support base 22. The fluid passes between the filtration disks 7 of the stack and accedes to the internal volume of the filtration disks 7 stack as a filtrate. The majority of the filtrate exits the disks 7 via a filtrate discharge port 11 adjacent to a connecting shaft 20, past an open discharge valve 21 and enters a filtrate plenum 19 for transfer, via a filtrate discharge outlet 14, to process. A fraction of the filtrate transpires through orifice sets 9 and 10 and is conveyed, via hollow support tubes 8, through a support plate 17, downward into the present invention, via back flush conveyance tubes 8, and discharges from tubing outlets 26 into the lower section of a reaction chamber 35. Air or gas enclosed within the reaction chamber 35 is released through an air or gas vent port 29 as the reaction chamber 35 fills with filtrate. The air or gas vent 29 closes when the reaction chamber 35 is full. The chemistry of the filtrate contained within the reaction chamber 35 is monitored via a chemical sensor 31 located in sensor port 34. Chemicals necessary to achieve the optimum filter disk cleaning efficiency are injected into the reaction chamber 35 via chemical inlet port 30. The temperature of the filtrate necessary to achieve the optimum filter disk cleaning efficiency is controlled within the reaction chamber 35 by means of a thermostatically controlled heating element 33 inserted into the reaction chamber 35 via an insertion port 32.

Description—FIG. 34b

As described for the illustration of FIG. 34a, direct to obtaining the effect of the invention, there is an embodiment onto which twin filters are serviced by one reaction chamber device as cited herein with the primary modification being of increased size, so as to service the additional filter. The invention, as illustrated, is configured for back flush service to dual filter units of a co-pending patent of the inventor The embodiment so configured is illustrated as FIG. 34b. In practice, such an embodiment is preferential when spatial constraints exist. The referenced illustration of this embodiment also demonstrates the right angle orientation between the filter units and reaction chamber of the present invention in a manner similar to the embodiment as illustrated on FIG. 32a and 32b. As was described for the embodiment illustrated on FIG. 32b, it is useful to establish a horizontal orientation of a disk stack in the filter units while maintaining a vertical orientation of the reaction chamber body. Horizontal orientation of the filter body is advantageous in some applications to facilitate distributed opening of the disk stack during back flushing. Such orientation is also helpful for the discharge of heavy particulate. A vertical orientation for the reaction chamber is advantageous to assure proper segregation and orientation of compressed air or gas and treated filtrate in the reaction chamber during back flushing.

During the back flushing operation high pressure compressed air or gas is introduced into a reaction chamber 35 of the present invention via an air or gas inlet port 28. Chemically and thermally treated filtrate fluid in the reaction chamber 35 is forced, under pressure, downward in the reaction chamber 35 and upward into the open lower ends 26 of back flush conveyance tubes 8. The pressurized fluid is continually forced upward in the conveyance tubes 8 as compressed air or gas, entering via the air or gas inlet port 28, continues to fill and displace fluid downward in the reaction chamber 35. High pressure air or gas in the upper section of the reaction chamber 35 transpires through reaction orifice 27 thereby atomizing into and becoming entrained within the treated filtrate as it is conveyed past the reaction orifice 27 and upwards into an attached filter unit. The high pressure, air or gas entrained, treated filtrate fluid is conveyed through a tubular support base 17, through a filtrate plenum chamber 19 and through a disk support base 22 and seal 18. The fluid initially passes orifice sets 9 and 10 and into a sealing plunger assembly 6. The pressure exerted by the fluid drives the sealing plunger 6 in the upstream direction compelling a plunger valve seat 4 onto a valve seat receiver end of the inlet port 3, effectively shutting off unfiltered water entering from supply 1. Concurrent with this action, the backside of the sealing plunger assembly 6 moves away from filtration disk 7 stack, thereby releasing compression of the disks 7 in the axial direction. Further, the motion of the sealing plunger assembly 6 draws tension upon a connecting shaft 20 pulling a filtrate valve assembly 21 in a sealing relationship to a receiver surface on the downstream side of a disk support base 17, thereby sealing the upstream side of the disk support base 17 from a filtrate plenum region 19. The pressurized fluid exits internal tubular support members 8 from paired orifice 9 and 10, thereby generating a plurality of air or gas entrained fluid jets 9a and 10a as coplanar, essentially equal velocity jets. These jets 9a and 10a impinge upon the released filter disks 7 and, as a consequence of the high pressure entrained air or gas, purvey a high pressure, pneumatically enhanced and maintained, hydraulic scouring and cleaning action upon the filter disk 7 surfaces. The back flush fluid jets 9a and 10a discharge across the filter disks 7 in nearly opposing directions with the entrained air or gas expanding and driving the treated filtrate back flushing fluid in an explosive fashion across the filter disk surfaces 7. As a consequence, debris adhering to the disk 7 surfaces is strongly impacted from different directions, thereby purveying a dramatically enhanced cleaning efficacy of the disks 7. Further, the slightly nonparallel opposite directions of jet fluids 9a and 10a generate slightly unequal drag forces across the disk 7 surfaces. The back flush fluid jet 9a ejected from orifice 9 tends to drag the filter disks 7 in a right handed rotational direction. The back flush fluid jet 10a ejected from orifice 10 tends to drag the filter disks 7 in a left handed rotational direction. As a consequence of the slight variance from opposite of the impact angles of the of the jets 9a and 10a upon the filter disks 7, a slight rotational motion is imparted to the disks 7. This motion, in concert with the two nearly opposite impact angles of jets 9a and 10a, assure an essentially full 180 degree aggressive scouring action across the filter disk 7 surfaces which delivers superior cleaning efficiency. The slight variance from opposite of the impact angles of the jets 9a and 10a is important to assure a slow rotational speed of the impacted disks 7. High rotational speed results in a detrimental variance of the relative velocity of impact between the jets 9a and 10a and the disks 7. The effect of this variance is a bias of the cleaning efficiency of the jets impacting the disk 7 surfaces in an oncoming fashion relative to that of the jets impacting the disk 7 surfaces in a retreating fashion. Such bias reduces the overall cleaning effectiveness of the disks 7.

Spent and solids laden back flush waste fluid and decompressed air or gas exits external to the back flushed disk 7 stack and is conveyed in an annular space between the external surface of the disk 7 stack and internal to filter body 15 to waste discharge plenum 19 and then to outlet 2 for discharge.

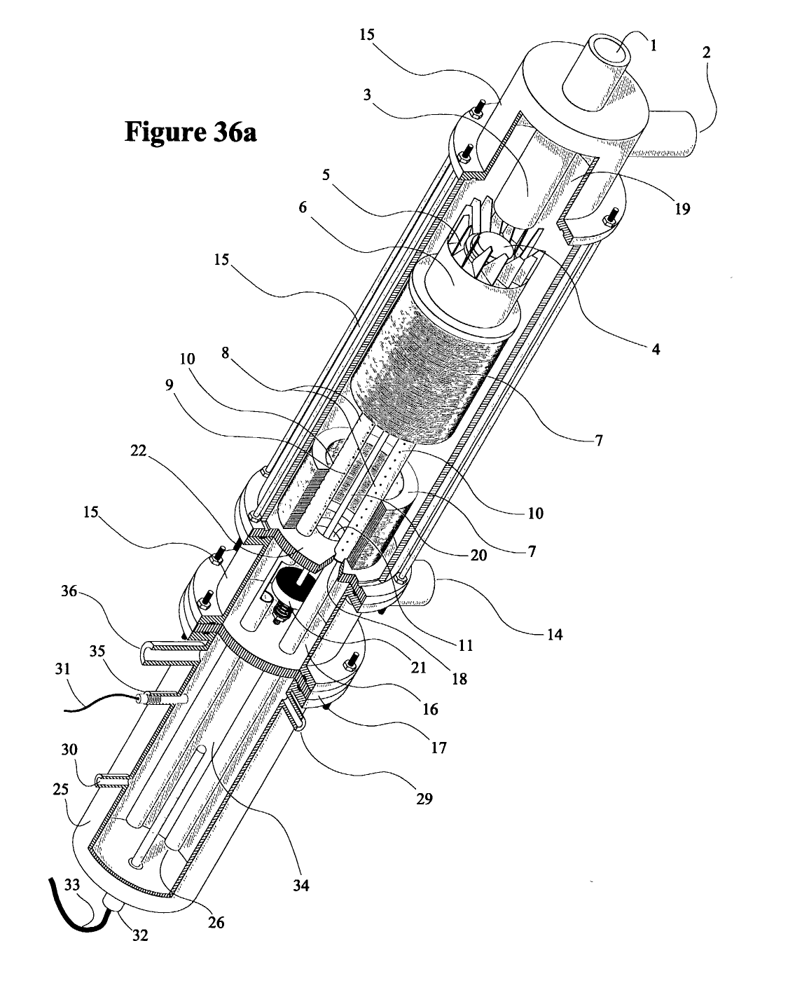

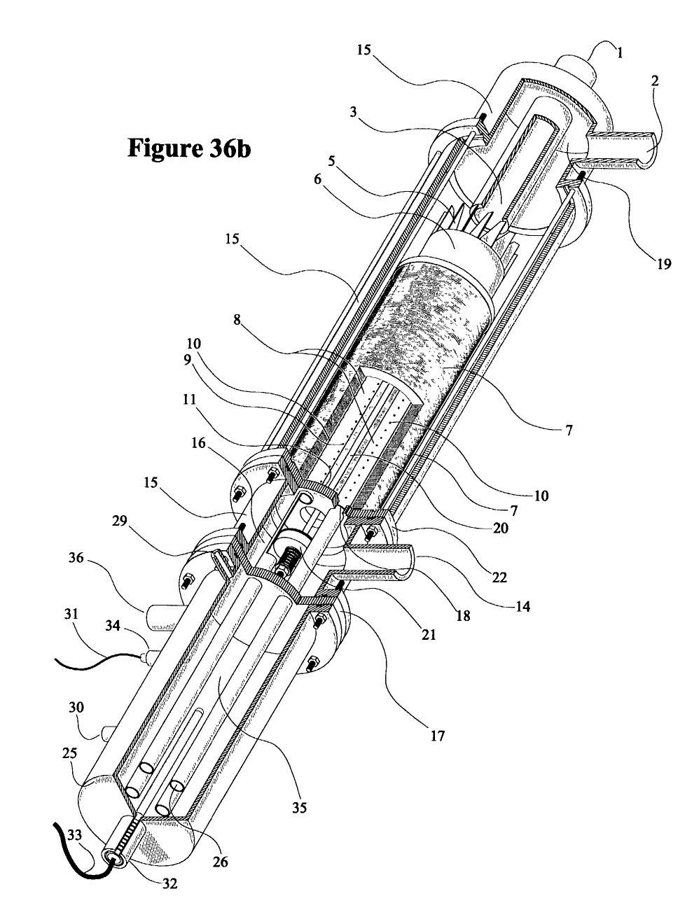

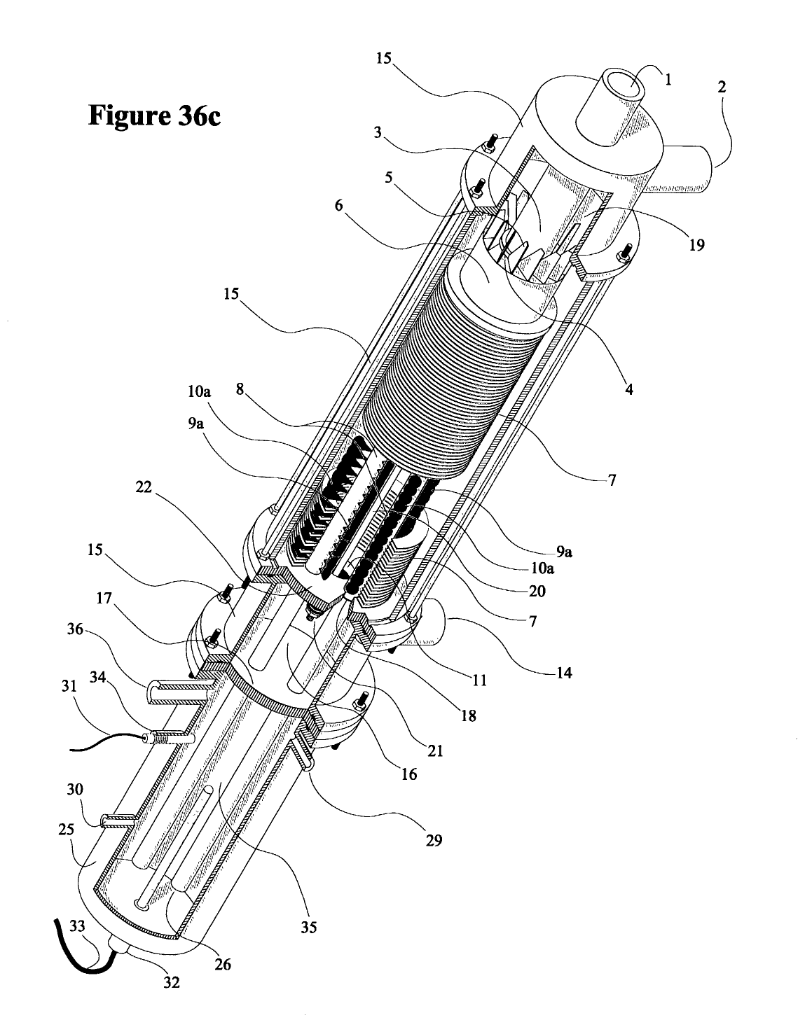

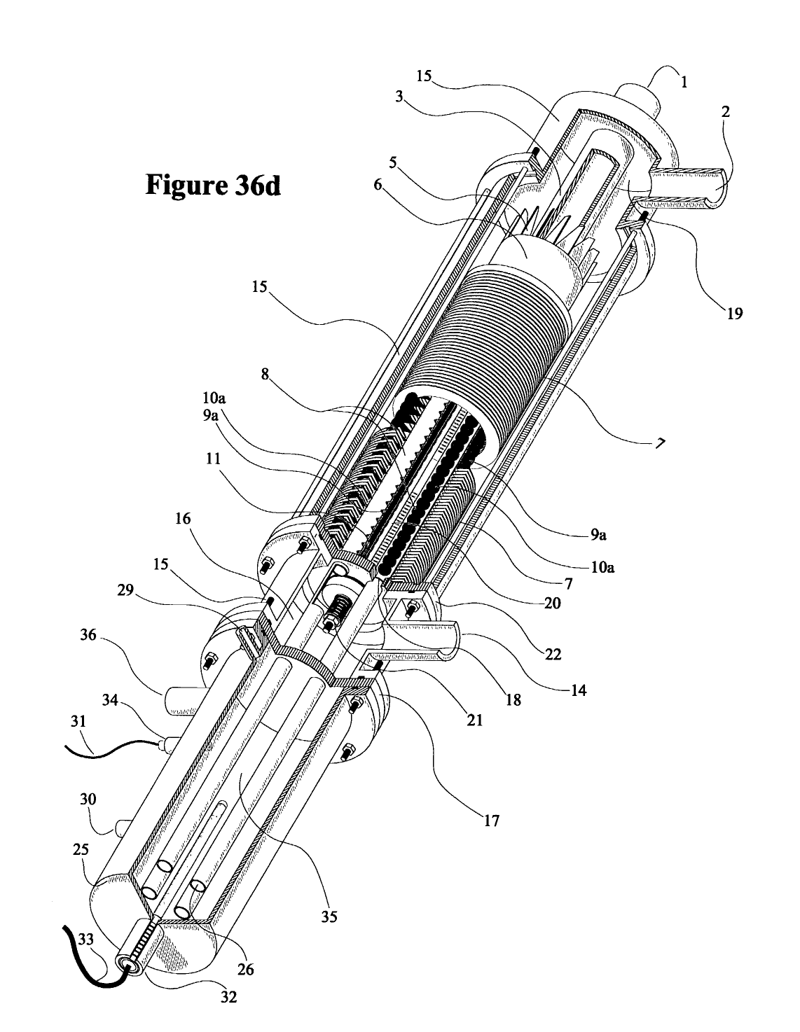

Description—FIGS. 36a and 36b

Direct to obtaining the effect of the invention, an embodiment, operating in the filtration mode, is illustrated in perspective on FIG. 36a as an inclined to the upstream view and FIG. 36b as an inclined to the downstream view. The invention, as illustrated, is configured for back flush service to a filter unit of a co-pending patent of the inventor Operational definition of this embodiment is as follows.

Unfiltered fluid is introduced under pressure into a filter body 15 via inlet I of a filter unit. The unfiltered fluid travels through inlet port 3 and discharges from a valve seat receiver end of the inlet port 3 onto a inlet valve seat area 4 located on top of a sealing plunger 6. The unfiltered fluid impacts against the inlet valve seat area 4 and is impelled by the impact radially outward, acquiring a swirl while passing through turning vanes of a centrifugal inlet impeller 5.

The swirling, unfiltered fluid passes through an annular space between an interior surface of filter body 15 and external to the surface of filtration disks stack 7. The upstream end of the filtration disks 7 stack is sealed by the backside of a sealing plunger 6, being in the opened inlet, filtration mode position. The downstream end of the filtration disks 7 stack is sealed by a disk support base 22. The fluid passes between the filtration disks 7 of the stack and accedes to the internal volume of the filtration disks 7 stack as a filtrate. The majority of the filtrate exits the disks 7 via a filtrate discharge port 11 adjacent to a connecting shaft 20, past an open discharge valve 21 and enters a filtrate plenum 19 for transfer, via a filtrate discharge outlet 14, to process. A fraction of the filtrate transpires through orifice sets 9 and 10 and is conveyed, via hollow support tubes 8, through a support plate 17, downward into the present invention, via back flush conveyance tubes 8, and discharges from tubing outlets 26 into the lower section of a reaction chamber 35. Air or gas enclosed within the reaction chamber 35 is released through an air or gas vent port 29 as the reaction chamber 35 fills with filtrate. The air or gas vent 29 closes when the reaction chamber 35 is full. The chemistry of the filtrate contained within the reaction chamber 35 is monitored via a chemical sensor 31 located in sensor port 34. Chemicals necessary to achieve the optimum filter disk cleaning efficiency are injected into the reaction chamber 35 via chemical inlet port 30. The temperature of the filtrate necessary to achieve the optimum filter disk cleaning efficiency is controlled within the reaction chamber 35 by means of a thermostatically controlled heating element 33 inserted into the reaction chamber 35 via an insertion port 32.

Description—FIGS. 36c and 36d

Direct to obtaining the effect of the invention, an embodiment, operating in the back flushing mode, is illustrated in perspective on FIG. 36c as an inclined to the upstream view and FIG. 36d as an inclined to the downstream view. The invention, as illustrated, is configured for back flush service to the filter unit of a co-pending patent of the inventor. Operational definition of this embodiment is as follows.

During the back flushing operation high pressure fluid is introduced into a reaction chamber 35 of the present invention via an inlet port 28. The chemically and thermally treated filtrate fluid in the reaction chamber 35 is forced, under pressure, downward in the reaction chamber 35 and upward into the open lower ends 26 of back flush conveyance tubes 8. The pressurized fluid is continually forced upward in the conveyance tubes 8 toward the filter unit as high pressure fluid enters via the inlet port 28, continues to fill and displace fluid in the reaction chamber 35. The high pressure, treated filtrate fluid is conveyed through a tubular support base 17, through a filtrate plenum chamber 19 and through a disk support base 22 and seal 18. The fluid initially passes orifice sets 9 and 10 and into a sealing plunger assembly 6. The pressure exerted by the fluid drives the sealing plunger 6 in the upstream direction compelling a plunger valve seat 4 onto a valve seat receiver end of the inlet port 3, effectively shutting off unfiltered water entering from supply 1. Concurrent with this action, the backside of the sealing plunger assembly 6 moves away from filtration disk 7 stack, thereby releasing compression of the disks 7 in the axial direction. Further, the motion of the sealing plunger assembly 6 draws tension upon a connecting shaft 20 pulling a filtrate valve assembly 21 in a sealing relationship to a receiver surface on the downstream side of a disk support base 17, thereby sealing the upstream side of the disk support base 17 from a filtrate plenum region 19. The pressurized fluid exits internal tubular support members 8 from paired orifice 9 and 10, thereby generating a plurality of high pressure fluid jets 9a and 10a as coplanar, essentially equal velocity jets. These jets 9a and 10a impinge upon the released filter disks 7 and, as a consequence of the high pressure, purvey a high pressure, hydraulic scouring and cleaning action upon the filter disk 7 surfaces. The back flush fluid jets 9a and 10a discharge across the filter disks 7 in nearly opposing directions. As a consequence, debris adhering to the disk 7 surfaces is strongly impacted from different directions, thereby purveying a dramatically enhanced cleaning efficacy of the disks 7. Further, the slightly nonparallel opposite directions of jet fluids 9a and 10a generate slightly unequal drag forces across the disk 7 surfaces. The back flush fluid jet 9a ejected from orifice 9 tends to drag the filter disks 7 in a right handed rotational direction. The back flush fluid jet 10a ejected from orifice 10 tends to drag the filter disks 7 in a left handed rotational direction. As a consequence of the slight variance from opposite of the impact angles of the of the jets 9a and 10a upon the filter disks 7, a slight rotational motion is imparted to the disks 7. This motion, in concert with the two nearly opposite impact angles of jets 9a and 10a, assure an essentially full 180 degree aggressive scouring action across the filter disk 7 surfaces which delivers superior cleaning efficiency. The slight variance from opposite of the impact angles of the jets 9a and 10a is important to assure a slow rotational speed of the impacted disks 7. High rotational speed results in a detrimental variance of the relative velocity of impact between the jets 9a and 10a and the disks 7. The effect of this variance is a bias of the cleaning efficiency of the jets impacting the disk 7 surfaces in an oncoming fashion relative to that of the jets impacting the disk 7 surfaces in a retreating fashion. Such bias reduces the overall cleaning effectiveness of the disks 7.

Spent and solids laden back flush waste fluid exits external to the back flushed disk 7 stack and is conveyed in an annular space between the external surface of the disk 7 stack and internal to filter body 15 to waste discharge plenum 19 and then to outlet 2 for discharge.

Conclusion, Ramifications, and Scope

The knowledgeable reader will certainly appreciate the advantages of the invention in providing a means for substantially improving the back flush cleaning efficiency and therefore enhancing the overall operating performance of filtration devices, particularly those devices employing disks as the filtration elements In contrast to the prior art, the reader will note that the invention provides dramatically improved performance service for a wide range of filtration applications in an efficient, simple, reliable, geometrically compact and cost effective manner.

In further contrast to the prior art, the reader will note that the invention provides the means for efficient filtration performance without the need for the troublesome and costly high volume back flush valves required in embodiments of the prior art. Elimination of these valves reduces the capital and operating costs previously exacted by the prior art. Additionally, elimination of these valves provides a substantial advantage over the prior art in empowering the employment of aggressive chemicals for back flush cleaning enhancement. Often the chemicals required for efficient filtration element cleaning are aggressive to such an extent that they will damage or destroy the back flush valves necessary in the prior art. Inasmuch as the invention eliminates these valves, those applications not serviceable by the prior art, because of the requirement for chemical cleaning, can now be readily addressed by means of the invention. Similarly, those applications not practical, within the constraints of the prior art, due to the presence in the feed or filtrate of valve endangering aggressive chemicals, can now be readily serviced by the invention.

The invention further provides a means of establishing and maintaining a very high back flushing energy for maximum scouring and cleaning action of the filtration disks. As a consequence of the entrainment of compressed air or gas into the back flush fluid, high pressure is generated and maintained during the back flushing process. The filters serviced by the invention thereby maintain superior disk cleanliness and high performance. Accordingly, the frequency and duration of the back flushing cycle of the invention is minimized. Downtime, wear and tear on equipment and maintenance expenses are all substantially reduced while reliability is dramatically increased. The reduced back flushing frequency further affords the reduction of back flush waste water volume, thereby reducing waste treatment or disposal costs. The waste water volume reduction affords the potential for water pollution discharge abatement and indeed provides significant potential for the amelioration of environmental damage resulting from excessive discharge.

As a consequence of the of the proficiency of the invention in providing back flushing fluid at an elevated temperature, the cleaning process of the filtration elements can be substantially improved. Accordingly, the frequency and duration of the back flushing cycle of the invention is minimized. Downtime, wear and tear on equipment and maintenance expenses are all substantially reduced while reliability is dramatically increased. This benefit further affords the reduction of back flush waste water volume, thereby reducing waste treatment or disposal costs. Waste water volume reduction affords the potential for water pollution discharge abatement and indeed provides significant potential for the amelioration of environmental damage resulting from excessive discharge.

Further, there are many filtration applications wherein the separated solids are viscous or sticky at room temperature conditions and, as a consequence, staunchly adhere to the filtration disks. In many such applications these otherwise immovable solids can be readily purged with an elevated temperature flush. This advantage further opens the industrial market to successful disk filtration applications. As an additional consideration, high temperatures are often employed for biological sterilization purposes. Those applications in which filtration difficulties occur due to bio-fouling can be readily resolved through the exploitation of the sterilization attributes of elevated temperature back flushing.

As a consequence of the of the proficiency of the invention to provide chemical cleaning assistance to the back flush fluid, the cleaning efficiency of the filtration elements can be substantially improved. Accordingly, the frequency and duration of the back flushing cycle of the invention is minimized. Downtime, wear and tear on equipment and maintenance expenses are all substantially reduced while reliability is dramatically increased. This benefit further affords the reduction of back flush waste water volume, thereby reducing waste treatment or disposal costs. Waste water volume reduction affords the potential for water pollution discharge abatement and indeed provides significant potential for the amelioration of environmental damage resulting from excessive discharge.

There are many applications in the industrial market in which filtration processes are difficult as a result of the tenacity to which certain solids can adhere to filtration surfaces. Often chemical treatment at elevated temperatures is required to dispel these solids from the disk surfaces. As a consequence of the of the ability of the invention to provide both elevated temperatures and chemicals to the back flush fluid, the removal of such solids from the filtration elements can be assured, thereby providing a means to facilitate efficient filtration processes to such applications.

The invention provides a means to afford a flexibly designed, modular filtration unit configuration purveying reduced fabrication time, effort and expense, as well as ease of onsite modification. The costly custom fabrication practices of the prior art are eliminated. Further, the invention eliminates the costly and difficult onsite equipment alterations necessary with the prior art for facilitating changes in the filtration characteristics. These beneficial challenges to the prior art are further exemplified in the capability of the invention, when combined with a filtration unit, to supply a standardized unit from which all filtration systems can be fabricated without custom considerations.

The advantages over the prior art are substantial. Expensive, troublesome and inefficient filtration processes, suffering from ineffective back flush cleaning can be dramatically improved through employment of the invention. Further, new and novel processes, products or businesses, not previously feasible because of the performance limitations of the prior art, are made possible. The reader will also see that other advantages are inherent to the design and performance characteristics of the invention. Some of these additional advantages are:

The invention provides resolution of fundamental deficiencies of back flush flush cleaning effectiveness inherent in the filtration performance and expense of the prior art. Such deficiency resolutions being of particular importance to industrial applications of disk filtration processes.

In addition to providing superior performance for industrial applications, the invention can also provide enhanced back flushing performance for agricultural applications.

The invention affords a means to eliminate the fabrication expense, mechanical complexity and operational liabilities associated with the critical back flush valve assemblies of the prior art.

The invention eliminates the pressure drop and/or associated flow impediment accompanying the back flush valves of the prior art. Consequently the capital and operating costs, as well as the pumping energy requirements associated with filtration operation, are substantially reduced over that of the prior art.

The invention affords a means to eliminate the fabrication expense, mechanical complexity and operational liabilities associated with custom and application specific filtration system configuration as required with the prior art.

The invention provides the means to efficiently back flush filtration systems in those applications wherein either a sufficiently high filtrate pressure or a sufficiently high external source hydraulic pressure is not available.

The invention eliminates the failures and associated downtime, labor and maintenance expense resulting from plugging and fouling of the filtration surfaces with debris which require a chemically and/or thermally enhanced back flush medium to back flush clean.

The invention readily permits the use of filtration, particularly disk filtration, processes in which chemical or thermal bio sterilization properties are required of the back flush medium.

In contrast to the relatively low energy hydraulic jet back flushing action of the prior art, the invention exploits entrainment of dispersed compressed gas into the back flush fluid so as to pneumatically energize the back flush medium jetting upon the filtration surfaces. This pneumatically enhanced, high energy jetting action purveys a much more efficient cleaning activity upon the filtration surfaces than the prior art. The enhanced cleaning activity thereby provides the opportunity to readily exploit back flush-able filtration services in applications hitherto difficult or not possible with the prior art.

Although the foregoing description contains many examples and considerations, these should not be construed as limiting the scope of the invention but instead as affording examples and illustrations of some of the preferred embodiments of this invention. For example, there are many different configurations and orientations for placement of the reaction chamber relative to the filtration device. Similarly, there are many different configurations for the locations and orientations of inlets, outlets and assorted ports to the reaction chamber. Also, there can be many porting and sealing configurations and orientations.

Further, there are possible configurations wherein the reaction chamber is integrated into the confines of the filtration bodies as well as configurations wherein the reaction chamber is maintained in communication but separate from the filtration bodies.

Other obvious and meritable possibilities are those configurations wherein multiple chemicals react within the reaction chamber prior to or during the back flushing operation so as to generate a product which further enhances the back flushing efficiency. An example of such a situation would be in which chemicals reacting within the reaction chamber generate a high pressure gas for driving or enhancing the back flushing process. Indeed, such generated gas could supplement or replace the air or gas employed to pressurize and impel the back flushing operation.

It also is conceivable that filtrate from the outlet port could, if provided enough pressure, be routed for use to pressurize and drive the treated back flush fluid from the reaction chamber through the back flushing process. Further, it should be obvious to those familiar with the art, that porting into the reaction chamber could be employed to introduce filtrate or other cleansing or neutralizing media into the reaction chamber so as to provide a final flushing and purging action upon the filtration surfaces and associated confines. Whereby such flushing and purging provides for eradication of residual back flush medium prior to continuation of the filtration process.

The reader familiar with the art should also deem it obvious that porting could also be so devised so as to permit direct communication into the hollow tubes which convey the back flush fluid from the reaction chamber to filter. Such direct communication would provide the means to introduce flushing gas or air or additional chemicals into the back flushing media during the actual back flushing process.

Clearly, the scope, ramifications and potential of the invention are well beyond the discussions of this document and therefore the true scope and delineation of the invention must be determined by the appended claims and their legal equivalents, rather than the examples provided herein.

I claim the following:

1. A filter cleaning enhancement device comprised of a body assemblage hydraulically connected for fluid supply, hydraulically connected for fluid outlet conveyance to a filtration unit, pneumatically connected to a compressed gas source, the device being characterized to operate in a filling, static and discharging mode and comprising;
a) a substantially hollow and sealed reaction chamber adapted to a filter unit for the receiving of fluid intended for back flushing of the filter unit;
b) an inlet port to supply compressed gas into the reaction chamber;
c) outlet conveyance adapted into the reaction chamber and providing hydraulic communication between a back flush fluid inlet port of the filter unit and the reaction chamber;
d) pathways into the outlet conveyance to facilitate gaseous communication from the reaction chamber, into the outlet conveyance,
wherein, during the filtration mode, the arrangement so configured receives fluid into the reaction chamber, said fluid being held in said reaction chamber antecedent to the back flush cleaning requirement of the filter unit, wherein for the expedience of the back flushing process, said fluid being expelled from the reaction chamber through the outlet conveyance and into the back flush fluid entry port of the filter unit, wherein said expulsion is engendered by the admission of pressurized gas into the reaction chamber thereby driving and displacing the back flush fluid from the reaction chamber, through the outlet conveyance and into the back flush fluid inlet of the filter unit, whereby further, a fraction of the displacing pressured gas is sparged into the egressing back flush fluid via pathways through the outlet conveyance walls into the back flush fluid, antecedent to the expulsion of said fluid into the back flush fluid port of the filter unit.

2. The filter cleaning enhancement device of claim 1 wherein the reaction chamber body is rigidly attached as an integral component of the filter unit.

3. The filter cleaning enhancement device of claim 1 wherein the filter unit serviced by the device is a disk filter device.

4. The filter cleaning enhancement device of claim 1 wherein a gas vent is adapted to the reaction chamber.

5. The filter cleaning enhancement device of claim 1 wherein the outlet conveyance is via tubes internal to the reaction chamber.

6. The filter cleaning enhancement device of claim 1 wherein the gaseous communication pathways between the reaction chamber, external to the outlet conveyance and the interior confines of the outlet conveyance are orifice.

7. The filter cleaning enhancement device of claim 1 wherein a chemical injection port is adapted to the reaction chamber.

8. The filter cleaning enhancement device of claim 1 wherein a chemical sensor is adapted to the reaction chamber.

9. The filter cleaning enhancement device of claim 1 wherein a thermal control element is adapted to the reaction chamber.

10. A filter cleaning enhancement device comprised of a body assemblage hydraulically connected for fluid supply, hydraulically connected for fluid outlet conveyance to a filter unit, pneumatically connected to a compressed gas source, the device being characterized to operate in a filling, static and discharging mode and comprising;
a) a substantially hollow and sealed reaction chamber adapted to a filter unit for the receiving of fluid intended for back flushing of the filter unit;
b) an inlet port to supply compressed gas into the reaction chamber;
c) outlet conveyance adapted into the reaction chamber and providing hydraulic communication between the back flush fluid inlet port of a filter unit and the reaction chamber;
wherein, during the filtration mode, the arrangement so configured receives fluid into the reaction chamber, said fluid being held in said reaction chamber antecedent to the back flush cleaning requirement of the filter unit, wherein for the expedience of the back flushing process, said fluid being expelled from the reaction chamber through the outlet conveyance and into the back flush fluid entry port of the filter unit, wherein said expulsion is engendered by the admission of pressurized gas into the reaction chamber, thereby driving and displacing the back flush fluid from the reaction chamber, through the outlet conveyance and into the back flush fluid inlet port of the filter unit.

11. The filter cleaning enhancement device of claim 10 wherein the reaction chamber body is rigidly attached as an integral component of the filter unit.

12. The filter cleaning enhancement device of claim 10 wherein the filter unit serviced by the device is a disk filter device.

13. The filter cleaning enhancement device of claim 10 wherein a gas vent is adapted to the reaction chamber.

14. The filter cleaning enhancement device of claim 10 wherein the outlet conveyance is via tubes into the reaction chamber.

15. The filter cleaning enhancement device of claim 10 wherein a chemical injection port is adapted to the reaction chamber.

16. The filter cleaning enhancement device of claim 10 wherein a chemical sensor is adapted to the reaction chamber.

17. The filter cleaning enhancement device of claim 10 wherein a thermal control element is adapted to the reaction chamber.

18. A filter cleaning enhancement device comprised of a body assemblage hydraulically connected for fluid supply, hydraulically connected for fluid outlet conveyance to a filter unit, hydraulically connected to a high pressure fluid source, the device being characterized to operate in a filling, static and discharging mode and comprising;
a) a substantially hollow and sealed reaction chamber adapted to a filter unit for the receiving of fluid intended for back flushing of the filter unit;
b) an inlet port to supply high pressure fluid into the reaction chamber;
c) outlet conveyance adapted into the reaction chamber and providing hydraulic communication between the back flush fluid inlet port of a filter unit and the reaction chamber;
wherein, during the filtration mode, the arrangement so configured receives fluid into the reaction chamber, said fluid being held in said reaction chamber antecedent to the back flush cleaning requirement of the filter unit, wherein for the expedience of the back flushing process, said fluid being expelled from the reaction chamber through the outlet conveyance and into the back flush fluid entry port of the filter unit, wherein said expulsion is engendered by the admission of high pressure fluid into the reaction chamber thereby driving and displacing the back flush fluid from the reaction chamber, through the outlet conveyance and into the back flush fluid inlet port of the filter unit.

19. The filter cleaning enhancement device of claim 18 wherein the reaction chamber body is rigidly attached as an integral component of the filter unit.

20. The filter cleaning enhancement device of claim 18 wherein the filter unit serviced by the device is a disk filter device.

21. The filter cleaning enhancement device of claim 18 wherein a chemical injection port is adapted to the reaction chamber.

22. The filter cleaning enhancement device of claim 18 wherein a chemical sensor is adapted to the reaction chamber.

23. The filter cleaning enhancement device of claim 18 wherein a thermal control element is adapted to the reaction chamber.
